(19) United States
(12) Patent Application Publication
(10) Pub. No.: US 2012/0275763 A1
(43) Pub. Date: Nov. 1, 2012

(54) INFORMATION PROCESSING APPARATUS, INFORMATION RECORDING MEDIUM, AND INFORMATION PROCESSING METHOD

(75) Inventors: Kae Nagano, Tokyo (JP); Minako Takahashi, Tokyo (JP); Takeshi Takeuchi, Tokyo (JP); Noboru Murabayashi, Saitama (JP)

(73) Assignee: SONY CORPORATION, Tokyo (JP)

(21) Appl. No.: 13/281,697

(22) Filed: Oct. 26, 2011

(30) Foreign Application Priority Data
Nov. 4, 2010 (JP) P2010-247666

(51) Int. Cl. H04N 9/80; H04N 5/92

(52) U.S. Cl. 386/241; 386/248; 386/244; 386/E05.009; 386/E09.011

(57) ABSTRACT

An information processing apparatus includes a reproduction processing unit executing a process of reproducing a content item from a recording medium. The reproduction processing unit reads scenario data, which is reproduction sequence definition information of the content item stored in the recording medium, and a program, which executes reproduction control of the content item based on the scenario data, from the recording medium and reproduces the content time under the control of the program. The scenario data includes a plurality of different scenarios defining a plurality of different content item reproduction sequences. The reproduction processing unit executes a process of acquiring scenario selection information, a process of selecting the scenario based on the acquired scenario selection information, and the process of reproducing the content item based on the selected scenario.

### CROSS-REFERENCE TO RELATED APPLICATION

The present application claims priority from Japanese Patent Application No. JP 2010-247666 filed in the Japanese Patent Office on Nov. 4, 2010, the entire content of which is incorporated herein by reference.

### BACKGROUND

The present disclosure relates to an information processing apparatus, an information recording medium, and an information processing method capable of generating a content item or reproducing a content item from, for example, image or audio information.

A content item such as audio data such as music or image data such as a movie is stored in an information recording medium (record medium) such as the BD [Blu-ray Disc (registered trademark)] or DVD (Digital Versatile Disc) so as to be supplied to users. The BD [Blu-ray Disc (registered trademark)] using a blue laser is a disc capable of performing recording at a high density and is capable of recording a high-capacity image content item or the like as high-quality image data. Therefore, in recent years, the BD has increasingly been used.

The content storage disc can be loaded in various apparatuses such as a reproduction apparatus such as a disc player which a user owns or a PC (Personal Computer) so as to be reproduced.

For example, the BD [Blu-ray Disc (registered trademark)] is a medium capable of recording an HD image, which is a high-definition image, for a long time. In future, the BD is not to be limited to the content item such as a movie, but is expected to be used as a medium supplying various types of content items to users.

For example, the BD is expected to be used as a medium supplying an advertisement content supply medium. Specifically, when an advertisement activity is carried out to invite participants onto domestic and overseas tours, various tour details are recorded as image information or audio information and are supplied for the users. An advertisement content item including video data, music data, or the like is expected to be more effective than information supplied in a sheet form such as a pamphlet.

However, much time and money may be spent to produce a content item including video data or music data. For example, since a lot of tour companies prepare many tour plans in accordance with the seasons or the like, a problem may arise in that it is difficult in terms of cost or time to produce advertisement content items including individual image data or music data for the many tour plans, prepare individual discs, and supply the discs to users.

Examples of the related techniques disclosing advertisement using image data include Japanese Unexamined Patent Application Publication No. 2007-171255, Japanese Unexamined Patent Application Publication No. 2007-181041, and Japanese Patent No. 3562981.

### SUMMARY

It is desirable to provide an information processing apparatus, an information recording medium, and an information processing method capable of producing content items usable for various kinds of other objectives, storing and supplying the content items in a medium such as a disc, and reproducing a content item selected based on various scenarios corresponding to objectives or usages.

According to an embodiment of the disclosure, there is provided an information processing apparatus including a reproduction processing unit executing a process of reproducing a content item from a recording medium. The reproduction processing unit reads scenario data, which is reproduction sequence definition information of the content item stored in the recording medium, and a program, which executes reproduction control of the content item based on the scenario data, from the recording medium and reproduces the content time under the control of the program. The scenario data includes a plurality of different scenarios defining a plurality of different content item reproduction sequences. The reproduction processing unit executes a process of acquiring scenario selection information, a process of selecting the scenario based on the acquired scenario selection information, and the process of reproducing the content item based on the selected scenario.

In the information processing apparatus according to the embodiment of the disclosure, the scenario selection information may be keyword or code information input to a reproduction apparatus which loads the recording medium. The reproduction processing unit may execute a process of selecting a reproduction scenario based on the keyword or code information input to the reproduction apparatus.

In the information processing apparatus according to the embodiment of the disclosure, the scenario selection information may be medium identification information set for the recording medium. The reproduction processing unit may read the medium identification information of the recording medium loaded in the reproduction apparatus and the process of selecting the reproduction scenario based on the read medium identification information.

In the information processing apparatus according to the embodiment of the disclosure, the scenario selection information may be date information acquired from the reproduction apparatus loading the recording medium. The reproduction processing unit may execute the process of acquiring the date information and the process of selecting the reproduction scenario based on the acquired date information.

In the information processing apparatus according to the embodiment of the disclosure, when the process of reproducing the content item acquired from a server is defined in the scenario, the reproduction processing unit may acquire the content item from the server and executes the process of reproducing the content item.

In the information processing apparatus according to the embodiment of the disclosure, the reproduction processing unit may execute the process of reproducing the content item in a predetermined sequence by the use of a playlist file defining content item reproduction sequence information, when the process of reproducing the content item is executed by applying the program executing the reproduction control of the content item based on the scenario.

In the information processing apparatus according to the embodiment of the disclosure, the playlist file may have marks indicating a reproduction start position and a reproduction end position in a scene unit, which is a reproduction data unit, and the mark indicating the reproduction end position is set at a position before an actual data end position of a scene. The reproduction processing unit may start a process for reproduction end of the scene or transition to another scene based on the mark indicating the reproduction end position.

According to another embodiment of the disclosure, there is provided an information processing apparatus including: a scenario generation unit generating a scenario which is reproduction sequence definition information of a content item stored in a recording medium; and a program generation unit generating a program which executes reproduction control of the content item based on the scenario. The scenario generated by the scenario generation unit may include a plurality of different scenarios defining a plurality of different content item reproduction sequences. The program generated by the program generation unit may be a program executing a process of acquiring scenario selection information, a process of selecting the scenario based on the acquired scenario selection information, and a process of reproducing the content item based on the selected scenario.

In the information processing apparatus according to the embodiment of the disclosure, the scenario selection information may be keyword or code information input to a reproduction apparatus which loads the recording medium. The program may execute a process of selecting a reproduction scenario based on the keyword or code information input to the reproduction apparatus.

In the information processing apparatus according to the embodiment of the disclosure, the scenario selection information may be medium identification information set for the recording medium. The program may execute a process of reading the medium identification information of the recording medium loaded in the reproduction apparatus and the process of selecting the reproduction scenario based on the read medium identification information.

In the information processing apparatus according to the embodiment of the disclosure, the scenario selection information may be date information acquired from the reproduction apparatus loading the recording medium. The program may execute the process of acquiring the date information and the process of selecting the reproduction scenario based on the acquired date information.

According to still another embodiment of the disclosure, there is provided an information recording medium storing: a content item to be reproduced; scenario data which is reproduction sequence definition information of the content item to be reproduced; and a program executing reproduction control of the content item based on the scenario data. The scenario data includes a plurality of different scenarios defining a plurality of different content item reproduction sequences. A reproduction apparatus loading the information recording medium and reproducing the content item is able to execute a process of acquiring scenario selection information based on the program, a process of selecting the scenario based on the acquired scenario selection information, and a process of reproducing the content item based on the selected scenario.

In the information recording medium according to the embodiment of the disclosure, the information recording medium may store a playlist file defining content item reproduction sequence information. The playlist file may have marks indicating a reproduction start position and a reproduction end position in a scene unit, which is a reproduction data unit, and the mark indicating the reproduction end position is set at a position before an actual data end position of a scene. The reproduction apparatus loading the information recording medium and reproducing the content item may be able to start a process for reproduction end of the scene or transition to another scene based on the mark indicating the reproduction end position and to execute the transition to the scene without delay.

According to further still another embodiment of the disclosure, there is provided an information processing method executed in an information processing apparatus. The information processing apparatus includes a reproduction processing unit executing a process of reproducing a content item from a recording medium. The reproduction processing unit reads scenario data including a plurality of different scenarios defining a plurality of different content item reproduction sequences and a program executing reproduction control of the content item based on the scenario data. The reproduction processing unit acquires scenario selection information based on the program, selects the scenario based on the acquired scenario selection information, and reproduces the content item based on the selected scenario.

The other features and advantages according to the disclosure are apparent from the embodiments of the disclosure described below and the detailed description made with reference to the accompanying drawings. The configuration of a system in the specification is a logical collective configuration of a plurality of apparatuses and is not limited to a configuration in which apparatuses with a configuration are included in the same casing.

According to the embodiments of the disclosure, it is possible to realize a configuration in which the content item is reproduced in the plurality of different sequences in accordance with a predetermined sequence selection condition such as a keyword. The reproduction apparatus loading the recording medium such as a BD reads the scenario data including the plurality of different scenarios defining the plurality of different content item reproduction sequences and the program executing the reproduction control of the content item based on the scenario data, acquires the predetermined scenario selection information such as user input keyword in accordance with the program, executes the process of selecting the scenario based on the acquired scenario selection information, and reproduces the content item based on the selected scenario. With such a configuration, the content item optimum for a user or a content item provider can be selectively reproduced from various content items stored in one disc.

### BRIEF DESCRIPTION OF THE DRAWINGS

FIGS. 1A to 1C are diagrams illustrating an example of a content item and a use process of a content item according to an embodiment of the disclosure;

FIG. 2 is a diagram illustrating an example of a main menu picture;

FIG. 3 is a diagram illustrating an example of a content item reproduction process;

FIG. 4 is a diagram illustrating an example of a content item supplied to clients;

FIG. 5 is a diagram illustrating an example of a data generation process of recording in a first medium (BD or the like) executed in, for example, studio which is a content production company;

FIG. 6 is a diagram illustrating an example of a software application framework of a BD-J;

FIG. 7 is a diagram illustrating an example of transition of the content item reproduction process;

FIG. 8 is a diagram illustrating a specific example of the content item reproduction sequence based on various scenarios;

FIG. 9 is a diagram illustrating a specific example of the content item reproduction sequence based on various scenarios;

FIG. 10 is a diagram illustrating a specific example of the content item reproduction sequence based on various scenarios;

FIG. 11 is a diagram illustrating a specific example of the content item reproduction sequence based on various scenarios;

FIGS. 12A to 12D are diagrams illustrating an example of the structure of the data stored in the first medium such as a BD;

FIG. 13 is a diagram illustrating a picture example of a questionnaire and a present application;

FIG. 14 is a diagram illustrating an example of the reproduction data displayed when reply data to the questionnaire is sent to the seller of the product using a QR code;

FIG. 15 is a diagram illustrating an example of the configuration of an information processing apparatus reproducing a content item based on a scenario;

FIG. 16 is a flowchart illustrating a content item reproduction processing sequence executed by the information processing apparatus according to the embodiment of the disclosure;

FIG. 17 is a flowchart illustrating a content item reproduction processing sequence executed by the information processing apparatus according to the embodiment of the disclosure;

FIG. 18 is a flowchart illustrating a content item reproduction processing sequence executed by the information processing apparatus according to the embodiment of the disclosure;

FIG. 19 is a flowchart illustrating a content item reproduction processing sequence executed by the information processing apparatus according to the embodiment of the disclosure;

FIG. 20 is a diagram illustrating an example of the configuration of a server executing a content item supply process; and

FIG. 21 is a diagram illustrating an example of the configuration of a content item editing apparatus generating medium recording data.

### DETAILED DESCRIPTION OF EMBODIMENTS

Hereinafter, an information processing apparatus, an information recording medium, and an information processing method according to an embodiment of the disclosure will be described in detail with reference to the drawings. The description will be made as follows.

1. Examples of Structure and Use process of Content Item according to Embodiment of Disclosure

2. Scenario and Scenario Manager

3. Content Item Reproducing Process based on Scenario

4. Structure of Scenario

5. Multi Use Example of Disc in Combination with Disc ID and Scenario Manager

6. Example of Configuration of Information Processing Apparatus Executing Content Item

7. Content Item Reproduction Processing Sequence in Information Processing Apparatus

8. Examples of Configurations of Server and Content Item Editing Apparatus

### 1. Examples of Structure and Use Process of Content Item According to Embodiment of Disclosure

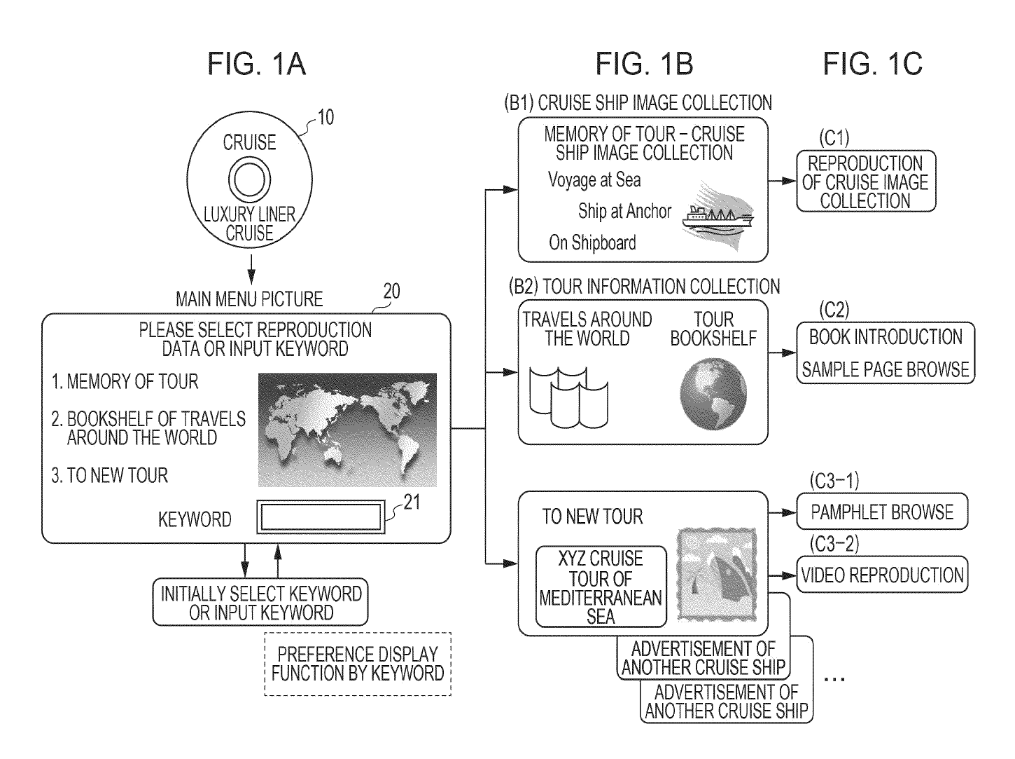

First, examples of the structure and the use process of the content item according to the embodiment of the disclosure will be described with reference to FIGS. 1A to 1C.

FIGS. 1A to 1C are diagrams illustrating the examples of the content item and the use process of the content item generated according to the embodiment of the disclosure.

FIGS. 1A to 1D show examples in which an advertisement content item generated according to the embodiment of the disclosure is recorded in a BD (Blu-ray Disc (registered trademark)) and is reproduced in a reproduction apparatus.

The BD (Blu-ray Disc (registered trademark)) stores a program which controls a process of reproducing a content item in addition to an image content including audio. The reproduction apparatus reads the program and executes the reproduction process in accordance with the program. A BD-J which is Java (registered trademark) corresponding to, for example, the BD is used for the program. In the specification, the BD storing the BD-J serving as a content item reproduction control program is referred to as a BD-J disc or a BD-J corresponding disc.

As shown in FIG. 1A, a main menu picture 20 is first displayed when a BD-J corresponding disc 10 is loaded and reproduced on the reproduction apparatus.

The disc 10 stores a scenario, which sets the sequence of the content item reproduction process, in advance.

The program (BD-J) stored in the disc 10 sequentially selects and reproduces content items based on the scenario.

The main menu picture 20 is a screen which is initially displayed on a display unit of a client after the disc 10 is inserted. For example, the main menu picture 20 includes a screen on which reproduction data can be selected by a user and a screen on which a keyword can be input.

In the example shown in Figures, a keyword input unit 21 is set in the main menu picture 20. Therefore, the user inputs, for example, a keyword recorded in a disc package in the keyword input unit 21.

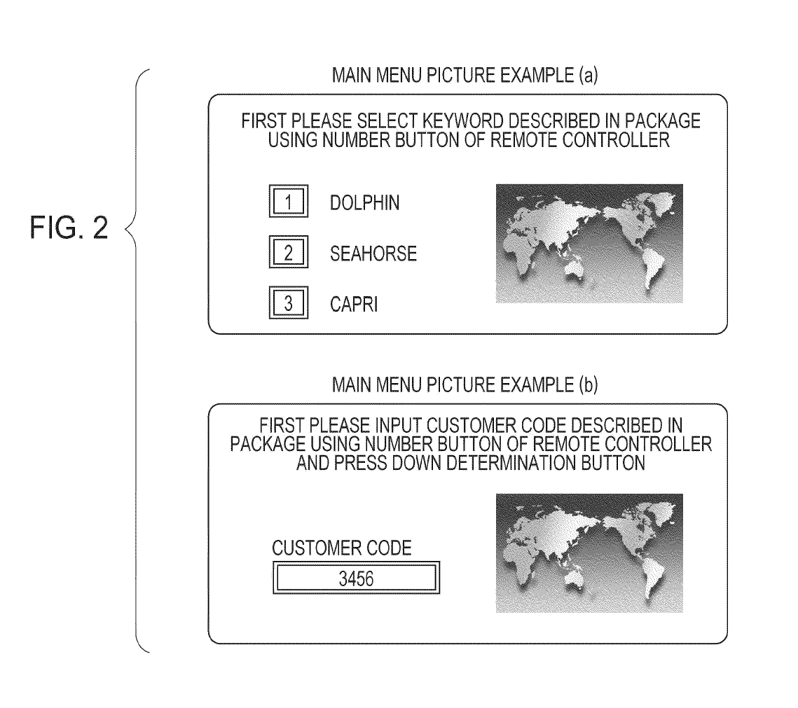

Examples of the main menu picture include examples shown in FIG. 2.

In FIG. 2, two main menu pictures are exemplified as follows:

(a) Example in Which Keyword Is Selectable; and

(b) Example in Which Code Is Input.

The keyword or the code is recorded in, for example, the package of the disc or the disc and the user inputs the keyword or the like viewing the package. Alternatively, communication with a predetermined management server is carried out via, for example, the Internet and a user registration is executed, various settings can be executed, for example, by using keyword or code data received from the management server.

As a method of inputting the keyword or the code, various methods such as a direct input method of inputting the keyword or the code through a keyboard or a voice can be applied in addition to the selection method.

When the user has completely input the keyword or the code, the reproduction control program such as the above-described BD-J selects a scenario defining a content item reproduction sequence in accordance with the input information and starts a process of reproducing a reproduction content item determined based on the selected scenario.

A scenario data file stored in the disc 10 includes a plurality of scenarios defining a plurality of different content item reproduction sequences. That is, the scenario data file is a content item reproduction sequence definition information file and has a structure in the plurality of different content item reproduction sequences. One scenario is selected in accordance with the selection of the user or the input keyword or code and a content item reproduction process defined based on the selected scenario.

The disc 10 stores a program that executes reproduction control of a content item based on scenario data. A reproduction processing unit of the reproduction apparatus executes the program. For example, the reproduction processing unit executes a process of acquiring scenario selection information such as a keyword, a process of selecting a scenario based on the acquired scenario selection information, and a process of reproducing a content item based on the selected scenario.

For example, when a content item stored in the disc is an advertisement content item for a tour such as a domestic and an overseas tour, a plurality of keywords regarding the tour is displayed on the main menu picture. Then, the user selects one keyword among the plurality of keywords using a predetermined operation unit such as a remote controller. As shown in FIG. 1B, a content item is automatically selected in accordance with the keyword and is preferentially reproduced through the selection of the keyword.

When the user directly inputs the keyword or the code using the keyboard or his or her voice, it can be considered that an error may occur in voice recognition of the input voice code or keyword information and the input code or keyword may not be identical to the preset keyword or code. In order to cope with this case, a configuration may be realized such that it is determined that the input keyword or code is identical to registration data when a predetermined identical degree set in advance is admitted in spite of the fact that the input keyword or code is not completely identical with the registration data. That is, the determination is performed in consideration of ambiguity. This technique is referred to as ambiguous retrieval.

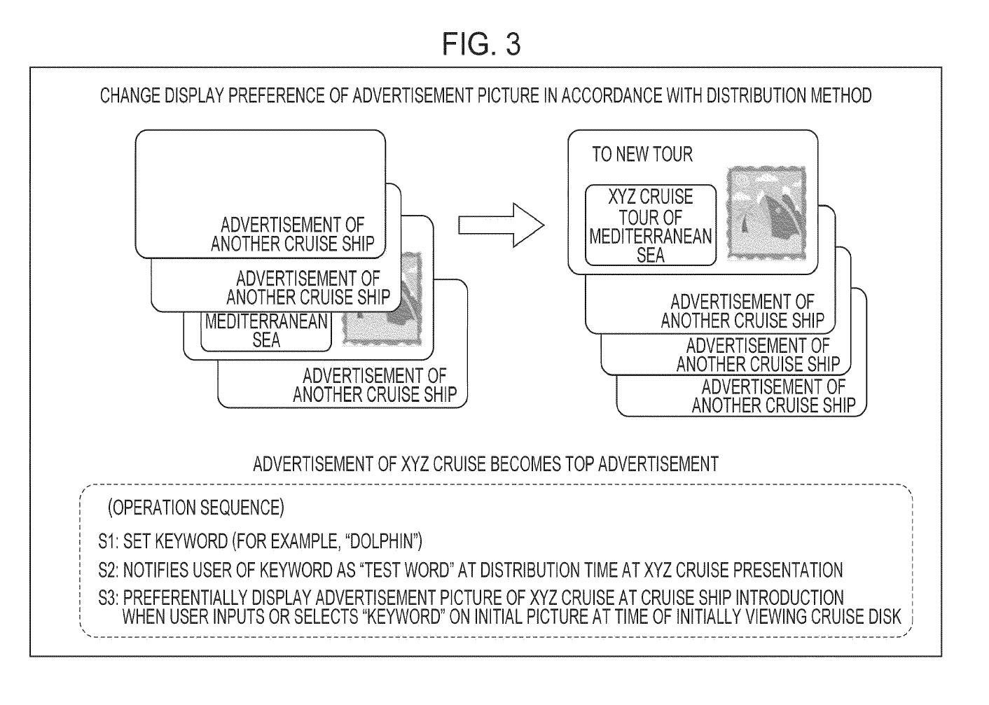

For example, the content item is reproduced in accordance with the input of the keyword, as shown in FIGS. 1B and 1C. An example of the content item reproduction process will be described with reference to FIG. 3.

Steps S1 to S3 of the lower part (operation sequence) of FIG. 3 are a specific example of the operation sequence in a case of an “advertisement site” in FIG. 1B.

S1: set a keyword (for example, a “dolphin”).

S2: notifies users of a keyword as a “password” in distribution as in an XYZ cruise presentation.

S3: preferentially display an advertisement picture of the XYZ cruise in an introduction of a cruise ship when the users first view a cruise disc and input or select a “keyword” on an initial picture.

For example, the program (BD-J) read from the disc starts the reproduction process by selecting the content item in this sequence.

For example, a content item of an advertisement site regarding a tour of a passenger ship is preferentially reproduced. The content item reproduced in the reproduction apparatus may be a content item which is stored in the disc 10 loaded on the reproduction apparatus or may be a content item which is received from a server connected via the Internet and reproduced by the reproduction apparatus.

For example, the program (BD-J) read from the disc stores access information (URL) of a server or access information (content item URL) regarding an individual content item. Therefore, the reproduction apparatus gains access to the server or the content item in accordance with the URL.

For example, when the reproduction apparatus gains access to the server using the URL of the server and supplies a disc ID read from the disc to the server, the server supplies a content item to the reproduction apparatus in accordance with the disc.

The reproduction apparatus stores the content item received from the server in a hard disc and executes the reproduction process.

A process of reproducing the content item stored in the disc (BD) and the content item received from the server is referred to as, for example, BD-Live.

In the BD-Live, a virtual file system formed by integrating the content item stored in the disc and the content item received from the server is set and the reproduction process is executed using the virtual file system. The reproduction process is disclosed in, for example, Japanese Unexamined Patent Application Publication No. 2009-289284 and Japanese Unexamined Patent Application Publication No. 2010-50676 which are filed previously by the same applicants as those of this disclosure.

Image or audio data supplied from the server on the Internet becomes a specific content item used by a client, for example, a content item of a specific scenario set in advance in correspondence with an advertisement content item. The server supplies the client with the image or audio data as the content item presented to the user based on the specific scenario.

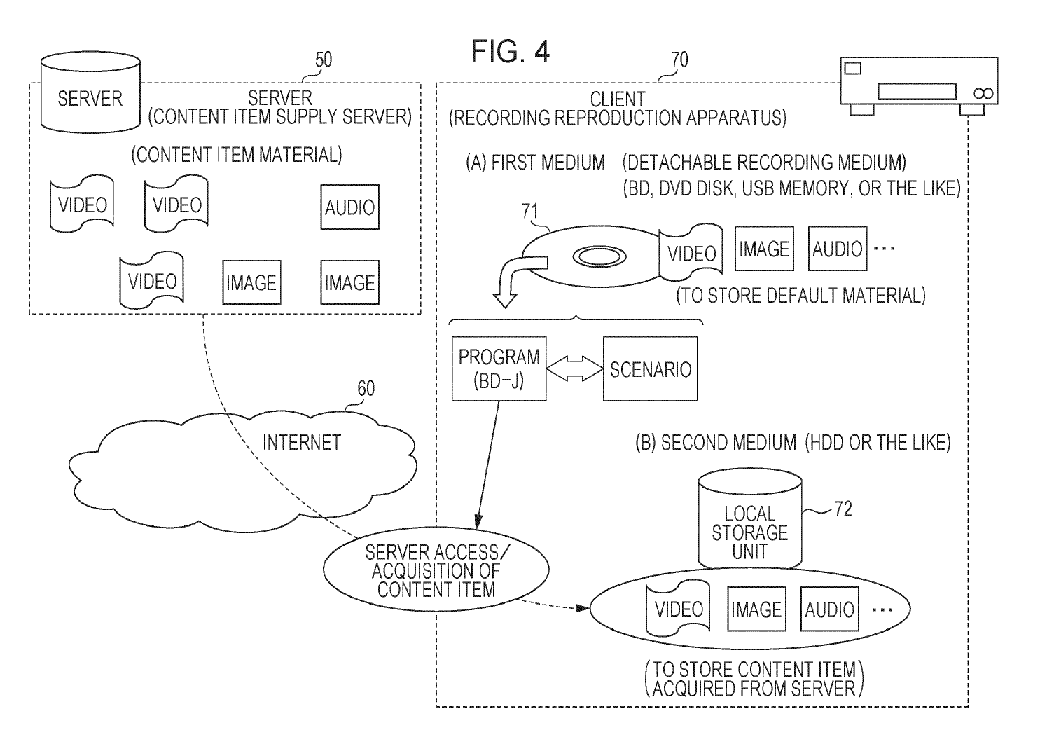

FIG. 4 is a diagram illustrating an example of the content item supplied to a given client.

In FIG. 4, a server 50 which supplies a content item and a client 70 which reproduces the content item are shown.

The client 70 loads a first medium 71 such as the BD storing the content item and reproduces the content item stored in the first medium 71, for example, an advertisement content item regarding a cruise.

The client 70 also stores a content item acquired from the server 50 in a second medium 72 configured by a local storage unit such as a hard disc and can reproduce the content item stored in the second medium 72.

The process of acquiring the content item from the server 50 is executed by the program (for example, the BD-J) stored in the first medium 71 such as the BD in a data processing unit such as a reproduction processing unit of the client 70. That is, the specific content item is acquired from the server 50 by gaining the access to the server 50 via a network such as an internet 60. Further, the content item acquired at this time is also a content item selected based on the scenario stored in the first medium 71.

The process of selecting and acquiring the content item can be executed in accordance with a content item identifier (for example, the content URL) set in advance in the scenario or the program (BD-J). Alternatively, a content item with a feature similar to the feature of the content item reproduced based on the scenario and stored in the first medium is retrieved from the content items stored in the server, a similar content item obtained through the retrieving is acquired, and the similar content item is stored in the second medium 72 of the client 70.

Whether the process is executed in this way is defined in the program (BD-J). The client (reproduction apparatus) 70 acquires the content item in accordance with the process defined in the program.

The process of reproducing the content time in the client 70 can be executed as a reproduction process in combination with a content item (default content item) stored in the first medium 71 such as the BD and a content item (content item acquired from the server) acquired from the server 50 based on the scenario set in advance. The reproduction process can be executed as a reproduction process executed by the above-described BD-Live, that is, a reproduction process executed using the virtual file system in which the content stored in the disc and the content received from the server are integrated with each other.

For example, in a display interval of a still image or text information with no recorded music, which are stored as the default data in the first medium 71, a process can be executed to display a video (moving image) obtained by reading the content item acquired from the server 50 from the second medium 72. Alternatively, in a display interval of a text read from the first medium 71, a process can be executed to reproduce audio data acquired from the server 50 as BGM data.

The reproduction control program executed in the client may detect a frame image suitable for the scenario among video data acquired from the server 50 and may reproduce the detected frame image together, for example, in the display interval of the text read from the first medium. In this case, the program (BD-J) is set as a program which executes a process of retrieving display data in the display interval of the text and a process of displaying the retrieval result.

### 2. Scenario and Scenario Manager

The client 70 shown in FIG. 3 executes the process of reproducing the content item stored in the first medium 71 such as the BD or the content item acquired from the server 50 based on the scenario stored in the first medium 71.

In the scenario stored in the first medium, as described above, the plurality of different content item reproduction sequences is set. For example, the reproduction sequence is selected in accordance with the keyword or the like input by the user.

The scenario is produced by, for example, Studio which is a content production company and is supplied to a medium (disc) manufacturing company so as to be stored in a medium (for example, a BD).

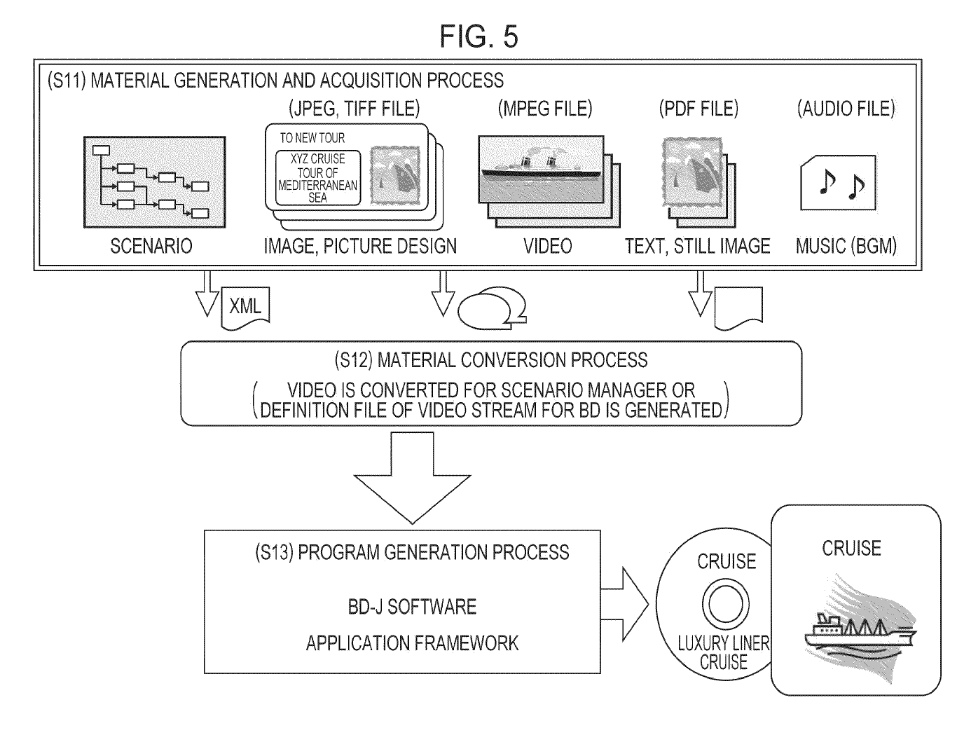

FIG. 5 is a diagram illustrating an example of a process of generating data stored in the first medium (such as a BD) executed in, for example, Studio which is a content item production company.

In step S11 shown in FIG. 5, a material is first generated and acquired.

As shown in FIG. 5, various data such as a scenario, an image (still image), a video (moving image), PDF data (text, image, and the like), and audio data are generated and acquired as the material of the data recorded in the disc.

For example, when the data is image data, the data has a format of MPEG, JPEG, TIFF, or the like. When the data is a scenario or the like, the data is XML data or the like.

Subsequently, in step S12, a data conversion process or the like is executed after the generation or the collection of the material. That is, for example, a process of converting a data form (format) corresponding to a medium storing the data and a process of generating a reproduction program are executed as the material conversion process.

For example, when a recording target medium is the BD, the conversion process is executed in accordance with the data form of the format defined in the BD. Specifically, for example, a playlist file is generated as reproduction control information of the BD, a process or the like of generating a clip file storing a reproduction content item is executed.

The material conversion process is executed as another process in accordance with a recording medium.

Thereafter, in step S13, a process of generating a program is executed. For example, when a recording medium is a BD, for example, a program corresponding to the BD standard is generated as the reproduction control program of the content item. Specifically, the program such as the BD-J is generated. The content item stored in the medium such as a BD is reproduced in accordance with the reproduction control program such as the BD-J. The reproduction sequence follows the definition of the scenario.

A content item such as a cruise advertisement stored in the medium can be generated by a software application of the BD-J. The application has a structure in which software applications having several processing functions are collected.

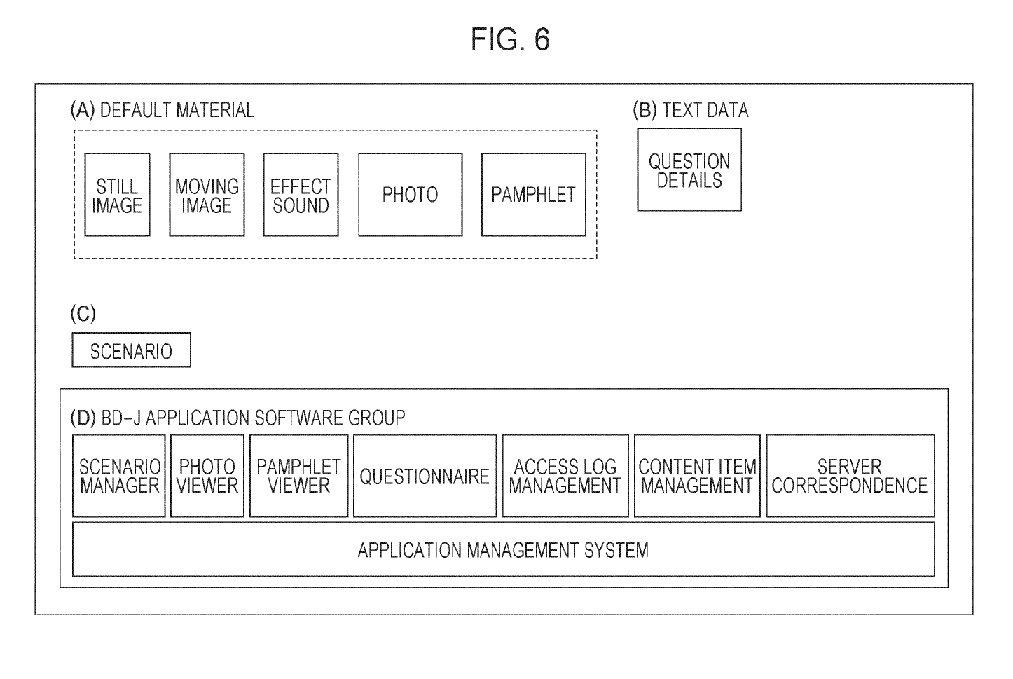

FIG. 6 is a diagram illustrating an example of a software application framework in the BD-J. As shown in FIG. 6, the framework includes data such as:

(A) default materials,

(B) text data,

(C) scenario data, and

(D) BD-J application software group.

(A) The default materials are content item data including image or audio data for default reproduction, when the recording reproduction apparatus which is a client may not acquire various content item materials from the server via, for example, the Internet. As shown in the drawing, the default materials include various kinds of data such as a still image, a moving image, a sound effect, a photo, a pamphlet.

(B) The text data includes data such as a descriptive text, a questionnaire, or a question to a user or data of a descriptive text of a guide, a manual, or the like.

(C) The scenario is definition data of the content item reproduction sequence. For example, the content reproduction details, the reproduction sequences of various materials, and the like are realized in accordance with various settings. For example, the scenario is data which defines the reproduction sequence of various content items reproducible by changing the reproduction details or the sequence of content items such as advertisements, promotions, images, or the like is changed in accordance with an advertisement provider or a user.

(D) The BD-J application software group is a software set applied to the content item reproduction process. For example, BD-J application software includes a program or the like executing content item reproduction control based on the scenario. A case where the BD-J application software is applied is a case where the recording medium is a BD. In the case of other media, a reproduction control program corresponding to the standard of the media is used.

As shown in the (D) various kinds of application software are included in the BD-J which is the reproduction control program. For example, the BD-J includes:

a scenario manager which executes the content item reproduction control based on the scenario;

a photo viewer which executes a still image reproduction process;

a pamphlet viewer which executes a process of reproducing a pamphlet including a still image;

a questionnaire processing program which executes questionnaire processing for a user;

an access log management program which executes access log management;

a content item management program which executes content item management;

a server corresponding program which gains access to the server or executes communication control; and

an application management system which activates the applications or executes conversion control.

### 3. Content Item Reproducing Process Based on Scenario

The content item reproduction process in the client is executed based on the scenario stored in the first medium (such as a BD), as described above. In the scenario, the plurality of content item reproduction sequences is defined. For example, the content item reproduction process is executed in accordance with one content item reproduction sequence (scenario X), for example, in response to the keyword or the code input by the user.

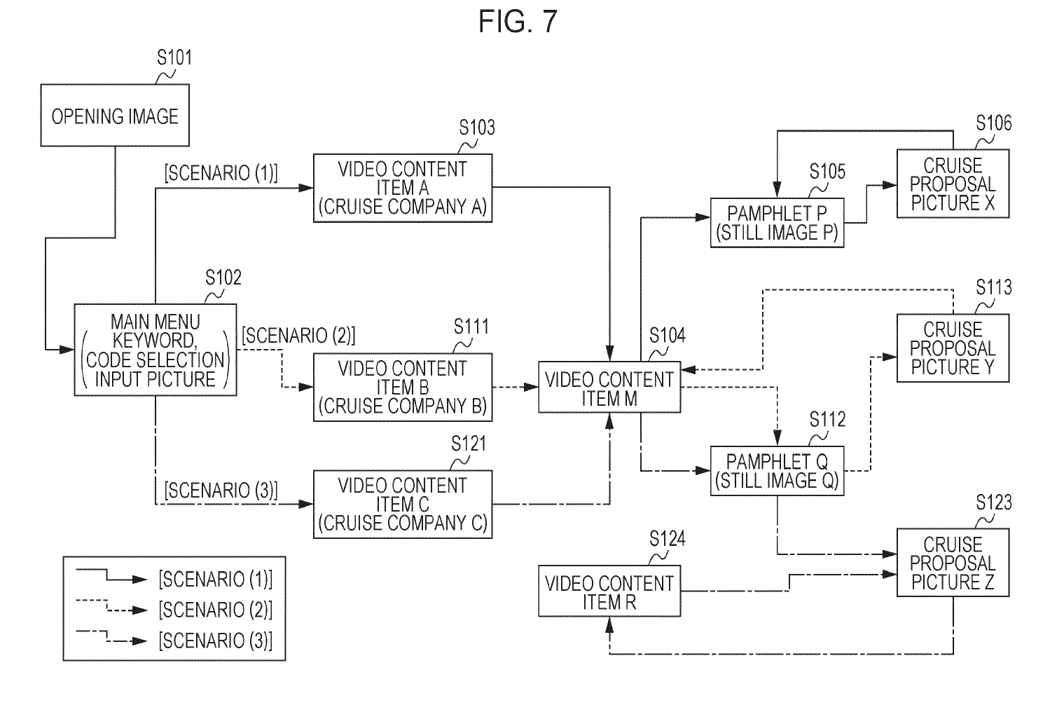

FIG. 7 is a diagram illustrating a transition example of the content item reproduction process based on the scenario. In FIG. 7, an example of the scenario stored in the first media is shown. In the scenario, three content item reproduction sequences of scenarios (1) to (3) are defined. Whether the content item reproduction process is executed based on one of the scenarios (1) to (3) is determined, for example, by the keyword or code information input by the user.

When reproduction of the first medium such as a BD starts, an opening image is first reproduced in step S101 and a main menu is displayed in step S102. The reproduction process from steps S101 and S102 is executed as a reproduction process common to all of the scenarios (1) to (3). This process is the common content item reproduction process before the scenario selection process.

The main menu displayed in step S102 is, for example, the picture described above with reference to FIG. 2. The user inputs the keyword or code information on the main menu picture. Alternatively, the user inputs selection information regarding a candidate of the keyword or code information presented on the picture.

One of the reproduction scenarios (1) to (3) is selected when the user inputs the selection information.

A scenario (1) is a content item reproduction sequence (S102-S103-S104-S105-S106) indicated by a solid line shown in FIG. 7.

A scenario (2) is a content item reproduction sequence (S102-S111-S104-S112-S113) indicated by a dotted line shown in FIG. 7.

A scenario (3) is a content item reproduction sequence (S102-S121-S104-S112-S123-S124) indicated by a one-dot chain line shown in FIG. 7.

The program (for example, the BD-J) read from the first medium as the reproduction control program determines whether the plurality of different scenarios are set and one of the scenarios is reproduced in accordance with the keyword or code information input by the user.

The keyword or the code is stored in, for example, a package (disc case) of the first medium supplied to the user. For example, in a main menu picture example as shown in FIG. 2, a keyword “dolphin” is set in a disc supplied by a company A, a keyword “seahorse” is set in a disc supplied by a company B, and a keyword “Capri” is set in a disc supplied by a company C.

In the discs supplied to the user by the companies A to C, the setting of the keyword of the package is different, but the content items stored in the discs are completely the same as each other.

That is, the companies A to C can purchase the disc storing the same content item and supply the disc to users.

Each company sets a dedicated keyword, stores the keyword in the dedicated package of each company, and supplies the disc stored in the package to users who are customers.

The users receiving the disc stored in the package can select and reproduce only the content item supplied by each of the different companies by inputting or selecting the keyword stored in the package on the menu picture viewing the keyword.

For example, in the scenario (1), the content item is reproduced in step S103 and the subsequent steps after the main menu of step S102.

In step S103, a company introduction video including the overview of the company A is reproduced.

In step S104, a video content item M such as guide information regarding, for example, the overseas locations of a cruise ship is reproduced.

In step S105, a pamphlet P including a still image used to describe the details of the cruise is presented.

In step S106, a proposal picture of a cruise tour provided by the company A is displayed.

In the scenario (2), the following content item is reproduced in step S111 and the subsequent steps after the main menu of step S102 is displayed.

In step S111, a company introduction video including the overview of the company B is reproduced.

In step S104, the video content item M such as guide information regarding, for example, the overseas locations of a cruise ship is reproduced.

In step S112, a pamphlet Q including a still image used to describe the details of the cruise is presented.

In step S113, a proposal picture of a cruise tour provided by the company B is displayed.

In the scenario (3), the following content item is reproduced in step S121 and the subsequent steps after the main menu of step S102 is displayed.

In step S121, a company introduction video including the overview of the company C is reproduced.

In step S104, the video content item M such as guide information regarding, for example, the overseas locations of a cruise ship is reproduced.

In step S112, the pamphlet Q including a still image used to describe the details of the cruise is presented.

In step S123, a proposal picture of a cruise tour provided by the company C is displayed.

In step S124, a dedicated video content item R of the company C is reproduced and displayed.

In this way, the content item reproduction process can be executed in the sequence unique to each of the scenarios (1) to (3).

For example, the video content item M reproduced in step S104 is set as a common content item reproduced in any of the scenarios (1) to (3).

Likewise, the pamphlet Q reproduced in step S112 is set as a common content item reproduced in any of the scenarios (2) and (3).

Thus, versatile use of the content items is possible by setting the common reproduction content items. Therefore, it is possible to reduce the generation cost of the content items.

In the scenario (1), for example, transition of the display picture between the cruise proposal picture X of step S106 and the pamphlet P of step S105 is executed as a loop process. Setting is made such that the transition is executed, for example, when the user inputs a command or a given time set in advance elapses from a display time of either picture.

In the scenario (2), transition of the display picture among the cruise proposal picture Y of step S113, the video content item M of step S104, and the pamphlet Q of step S112 is also executed as a loop process. Setting is made such that the transition is executed, for example, when the user inputs a command or a given time set in advance elapses from a display time of either picture.

In the scenario (3), for example, transition of the display picture between the cruise proposal picture Z of step S123 and the video content item R of step S124 is executed as a loop process. Video content item R is made such that the transition is executed, for example, when the user inputs a command or a given time set in advance elapses from a display time of either picture.

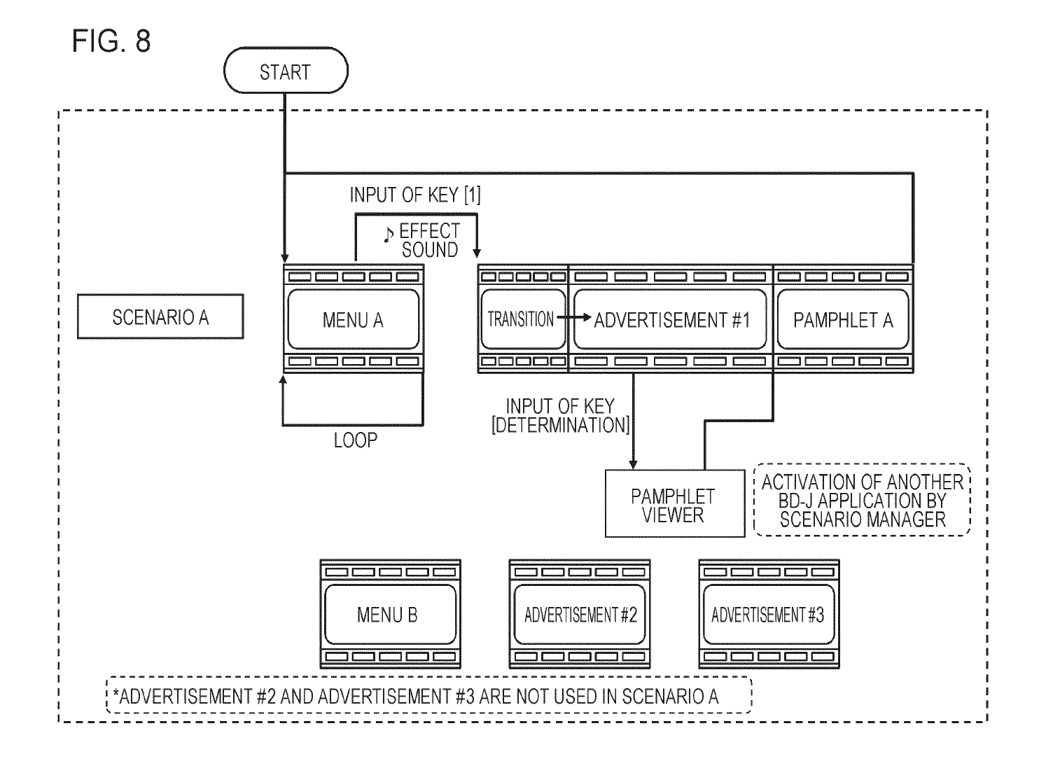

Next, a specific example of the content item reproduction sequence will be described based on various scenarios with reference to FIGS. 8 to 10.

FIG. 8 is a diagram illustrating an example of the content item reproduction sequence based on, for example, the scenario A selected as a one example.

The content item is reproduced based on the scenario A in response to the inputting of the keyword on a main menu picture (not shown), for example, the main menu picture described with reference to FIG. 2, or the inputting of a keyword selection number. In the scenario A, the picture of a menu A which is an initial picture corresponding to the scenario A is displayed from the main menu picture.

A sequence after the menu A is the content item reproduction sequence unique to the scenario A.

For example, an advertisement content item #1 is reproduced as the subsequent content item of the menu A.

The transition from the menu A to the advertisement content item #1 is executed by the inputting a key [1] of a remote controller which is an input device of the reproduction apparatus. The transition is controlled by the reproduction control program (for example, the BD-J) and a content item conversion process is executed. In the content item conversion process, setting may be made such that a sound effect is set.

When no key is input by the user, the menu A is repeatedly reproduced (loop process). When a predefined threshold time expires, setting may be made such that a subsequent content item may be automatically reproduced.

When the user inputs a key [determination] of the remote controller which is the input device of the reproduction apparatus during the reproduction of the advertisement content item #1, the pamphlet viewer is activated and the reproduction of the pamphlet A starts.

When the reproduction of the pamphlet A ends, the picture returns to the menu A and the reproduction process resumes from the menu A.

The content item reproduction sequence is the sequence defined in the scenario described above with reference to FIG. 7.

The reproduction control program (for example, a scenario manager of the BD-J) determines a content item to be reproduced based on the scenario read from the disc and reproduces the content item.

The pamphlet viewer shown in FIG. 8 is single software included in the BD-J application software group and is a program for browsing the pamphlet, as described above with reference to FIG. 6.

In this way, the transition between the respective reproduction content items is executed when the user inputs the key, for example, by operating the remote controller. Alternatively, the transition between the respective reproduction content items is executed based on detection information when the reproduction control program detects the elapse of the reproduction time.

As described above with reference to FIG. 6, the reproduction control program such as the BD-J includes the various kinds of application software, the application program is changed depending on the content item to be reproduced, and the content item is reproduced.

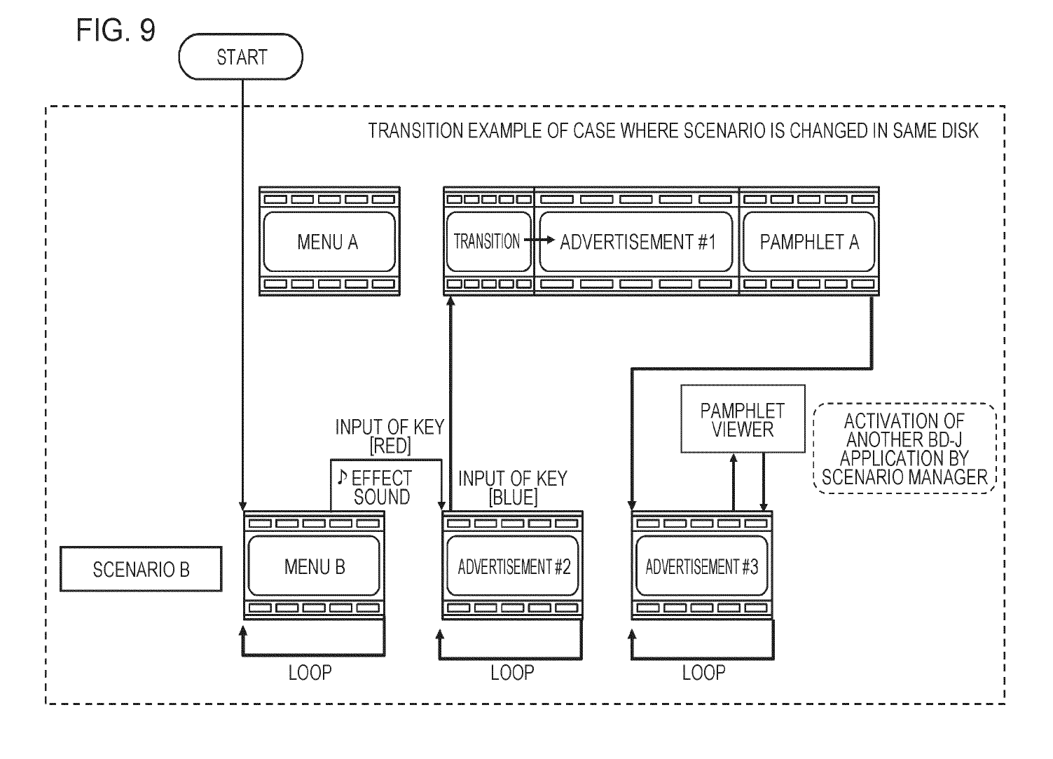

FIG. 9 is a diagram illustrating an example of the transition when the content item is reproduced based on another scenario in the disc storing the same content item as that described with reference to FIG. 8.

In FIG. 8, the content item is reproduced based on the scenario A. In FIG. 9, the content item is reproduced based on the scenario B.

The content item is reproduced based on the scenario B in response to the inputting of the keyword on a main menu picture (not shown), for example, the main menu picture described with reference to FIG. 2, or the inputting of a keyword selection number. In the scenario B, the picture of a menu B which is an initial picture corresponding to the scenario B is displayed from the main menu picture.

A sequence after the menu B is the content item reproduction sequence unique to the scenario B.

For example, an advertisement content item #2 is reproduced as the subsequent content item of the menu B.

The conversion from the menu B to the advertisement content item #2 is executed by the inputting a key [red] of a remote controller which is an input device of the reproduction apparatus. The conversion is controlled by the reproduction control program (for example, the BD-J) and a content item conversion process is executed. In the content item conversion process, setting may be made such that a sound effect is set.

When no key is input by the user, the menu B is repeatedly reproduced (loop process). When a predefined threshold time expires, setting may be made such that a subsequent content item may be automatically reproduced.

When the user inputs a key [blue] of the remote controller which is the input device of the reproduction apparatus during the reproduction of the advertisement content item #2, the content item starts to be reproduced, as in the scenario A described above with reference to FIG. 8.

In this way, even in the different scenarios, the setting can be made such that the common content item is reproduced.

In the scenario B, an advertisement #3 starts to be reproduced after the completion of the reproduction of the pamphlet A. The reproduction sequence is a sequence unique to the scenario B different from the scenario A described above with reference to FIG. 8.

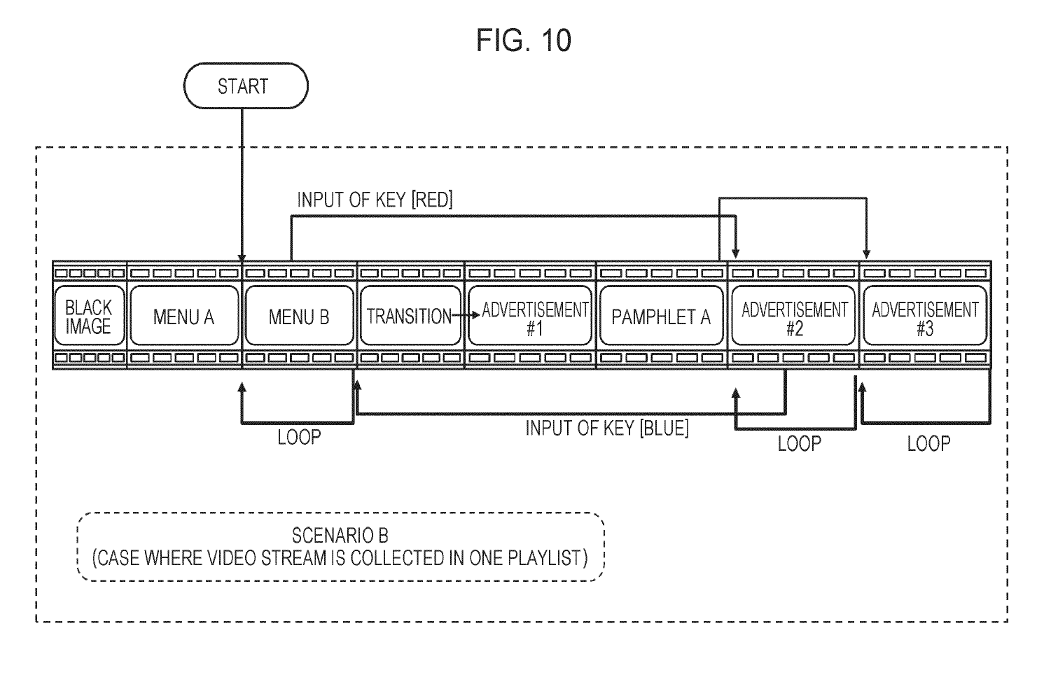

FIG. 10 is a diagram illustrating an example of input data of an AV clip as a content file reproducible with only one playlist when setting is made such that the content item is reproduced based on the scenario B, as in FIG. 9, and one playlist is set as a reproduction sequence definition file.

In order to reproduce the content item based on the scenario B by the use of only one playlist, the respective content items (reproduction data) of the menu B, the advertisement #1, the advertisement #2, and the advertisement #3 are continuously stored in one clip file. Reproduction designation information such as playlist marks, which serve as identifiers indicating a reproduction start point and a reproduction end point, is set at various content compartment positions of the input data of the clip file. Thus, the reproduction of the content item based on the scenario B is realized by the one playlist file.

That is, the mark (playlist mark) indicating the reproduction start position or the reproduction end position is defined at the compartment position of each of the content items of the menu B, the advertisement #1, the advertisement #2, and the advertisement #3. The control is possible depending on the positions of the marks by such setting. Therefore, the loop process of each content item unit in one clip file or a program conversion process accompanied by the content item conversion process can be smoothly executed.

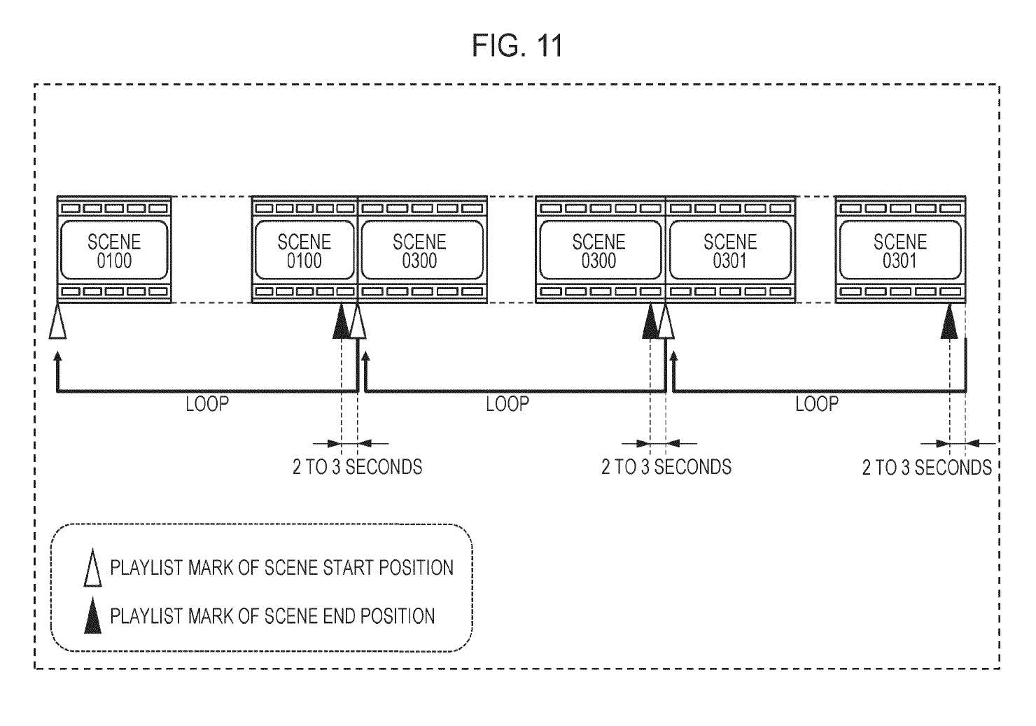

The setting form of the playlist mark will be described with reference to FIG. 11. In FIG. 11, a content item example separated by three scenes of scene 0100, scene 0300, and scene 0301 is shown.

The playlist mark (Δ: playlist mark of the scene start position) is set as reproduction start position information indicating a scene start in the top of each scene.

Further, the playlist mark (▴: playlist mark of the scene end position) for end determination is set at the end position of each scene in order to return to the start position with the scene end and continue the loop reproduction.

The playlist mark (▴: playlist mark of the scene end position) for end determination is set before a few seconds (before 2 to 3 seconds) of the end position of the actual scene end. The reason for setting the playlist mark in this way is to reliably transition to the reproduction end process up to the scene end or the loop process in consideration of a mark determination process by the hardware performance of the reproduction apparatus or a response performance.

That is, in the reproduction apparatus loading the recording medium (information recording medium) and reproducing the content item, the reproduction end of the scene or a reproduction transition process to another scene can start based on the mark indicating the reproduction end position. For example, the scene transition can be executed without delay.

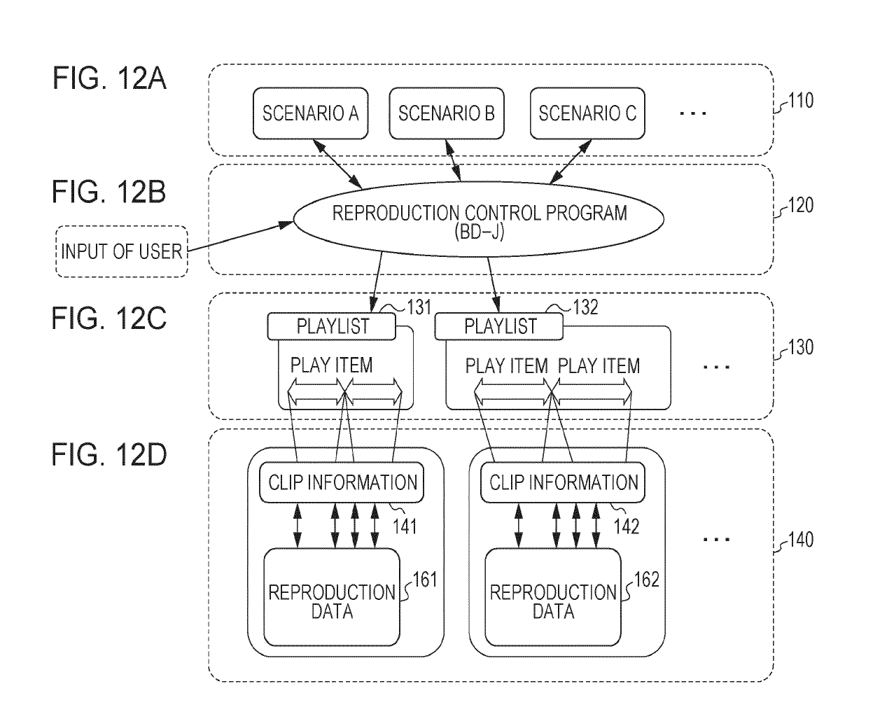

A structure example of data stored in the first medium such as a BD will be described with reference to FIGS. 12A to 12D. The structure of the data shown in FIGS. 12A to 12D indicate recording examples of data in conformity with the BD format.

As shown in FIGS. 12A to 12D, the content item stored in the first medium has a hierarchical structure of (A) scenario 110, (B) reproduction control program 120, (C) playlist 130, and (D) clip 140.

The reproduction control program 120 detects, for example, the keyword input by the user and selects the scenario to be reproduced. That is, the reproduction control program 120 selects one of the scenarios A, B, C, etc. shown in the drawing.

The playlist which is a reproduction control information file is selected in accordance with information regarding the selected scenario. As described above, the scenario is described using, for example, XML data and playlist selection information is included in the scenario.

The reproduction control program 120 executes the reproduction process using the playlist determined based on the scenario. For example, the reproduction control program 120 executes the reproduction process in accordance with the playlist selected from playlists 131, 132, etc. shown in the drawing.

The playlist includes a play item which is reproduction target data designation information. Reproduction data 161 and 162 which are actual data of the content item are selectively read for the reproduction process based on clip information 141 and clip information 142 serving as a reproduction section defined by the play item included in the playlist. The playlist can be set so as to include the plurality of play items.

### 4. Structure of Scenario

As described above, the content item is reproduced based on the scenario selected by the reproduction control program such as the BD-J. The scenario stored in the disc is described using, for example, the XML data, the scenario manager of the BD-J, which is an example of the program control program, analyzes the XML data, and the reproduction of the content item is controlled.

For example, the scenario described using the XML data has the following features.

A video material can be separated in a “scene” unit and can define various operations in the scene unit.

That is, the loop process of the scene unit or the setting or the like of the scene conversion condition can be defined, as described above with reference to FIGS. 8 to 11.

The definition is described using the XML data and is analyzed and executed by the reproduction control program.

For example, a reproduction form, a pause operation, or the like can be defined as a start action in the reproduction start.

Change in the reproduction form, change in the scene, conversion of a title, reproduction of a sound effect, a program to be activated can be defined and executed in response to, for example, a key operation such as an operation of channel buttons (1 to 12), a red, blue, or the like button, a determination button of the remote controller. A jump to another scene, the loop process, or the like can be also defined for an end action at the time of the reproduction end.

The execution of the acquisition of various logs can be described using the XML data. For example, various kinds of log data can be acquired by recording the XML data to acquire a log regarding the number of times of reproduction of a specific advertisement content item, a log regarding the number of times of reproductions of the content item in a specific sequence, a log regarding the number of times of activation of a specific application, a log regarding error occurrence, and the like.

The content item can be reproduced using, for example, the playlist, as described above with reference to FIGS. 11 to 12D.

Various moving image content items can be separated in a scene unit and the flow between the scenes or navigation of the key input can be designated in detail in the scenario. The scenario manager of the BD-J, which is an example of the reproduction control program, can reproduce the respective scenes or the pamphlet information or the like of the other still image as a moving image using the playlist.

When the content item reproduction process is executed as the process of reproducing the moving image using the playlist, it is possible to obtain one advantage that a BD reproducer can display the moving image at a drawing processing speed faster compared to the display of the still images and high-speed UI can be realized. For example, the transition time necessary to jump to each scene can be shortened by setting a moving image of the respective scenes in a play item, which is a reproduction unit of the playlist, and controlling the reproduction using the single same playlist.

For example, a display animation can be made to be a moving image at the time of the picture transition executed when the user operates a key. The display animation can be made to be the play item to be controlled, as the scene (moving image) for transition, using the playlist. Accordingly, even a producer with no system performance to the extent of executing a CG animation in real time can display a high-quality GUI.

When the content item is reproduced using the playlist file as a reproduction control file, for example, it is possible to obtain the advantage that portions partially extracted from a plurality of video streams can be reproduced seamlessly in sequence. That is, the reproduction can be smoothly executed in the reproduction sequence defined in the playlist.

Further, in the configuration according to the embodiment of the disclosure, the scenario manager realizes the production of the content item based on the scenario. That is, the production sequence can be designated at random by a unique scenario definition file. Further, by reproducing each picture or each moving image using the playlist, it is possible to improve the degree of freedom of the reproduction sequence of the content item and to transmit the reproduction content item at high speed.

5. Multi Use Example of Disc in Combination with Disc ID and Scenario Manager

Next, a multi use example of the disc in combination with a disc ID and the scenario manager.

For example, a different ID is stored in each disc such as a BD at the time of sampling in a process of manufacturing the disc. The ID is stored physically as cutting area information in a BCA (Burst Cutting Area) set in, for example, the inner circumference of the disc.

The client executing the reproduction of the disc can identify the disc by reading the disc ID and can select the scenario using disc identification information.

In the above-described processing example, the case has hitherto been described in which the user inputs the keyword or the like stored in the disc package to select the scenario. However, in the configuration in which the scenario is selected based on the disc ID, the scenario can be selected in accordance with the disc without the operation of the user.

With such a configuration, for example, it is possible to manufacture a lot of discs collectively storing the advertisement content items of a plurality of companies handling completely different products.

That is, the disc ID of the disc supplied by each company may be managed and a scenario setting a correspondence relationship between the disc ID and the selected scenario may be generated and stored in the disc.

Specifically, for example, the disc set in the following manner is supplied.

(A) Car Sales Company: Disc IDs=00001 To 02000

(B) Clock Sales Company: Disc IDs=02001 To 03000

(C) Food Sales Company: Disc IDs=03001 To 05000

(D) Tour Company: Disc IDs=05001 To 07000

The discs (IDs=00001 to 07000) are common discs which all store the content item and have only different disc IDs.

However, in regard to the scenarios stored in the discs, scenarios setting the reproduction sequences of the following four content items are included.

(A) Scenario A: Car Advertisement

(B) Scenario B: Clock Advertisement

(C) Scenario C: Food Advertisement

(D) Scenario D: Tour Advertisement

The reproduction control program (BD-J) stored in the disc is set as a program which reads the disc ID and executes a process of selecting the scenario in accordance with the read disc ID. Specifically,

(A) the scenario A is selected when the disc IDs=00001 to 02000.

(B) The scenario B is selected when the disc IDs=02001 to 03000.

(C) The scenario C is selected when the disc IDs=03001 to 05000.

(D) The scenario D is selected when the disc IDs=05001 to 07000.

By the setting, it is possible to manufacture a lot of discs collectively storing the advertisement content items requested from various companies. As a consequence, it is possible to reduce the unit cost by increasing the number of discs and reducing the stamping cost per unit, which occupies most of the BD-ROM cost. Thus, it is possible to considerably reduce the advertisement unit cost.

For example, the BD-ROM storing the content item is produced, it is necessary to pay the license fee to AACS which is a BD management organization in some cases. By executing the above-described process, only one license fee for each master for the stamping is paid. For example, when four companies separately produce the disc, the license fee is paid four times to AACS. Therefore, it is possible to obtain the advantage that the cost can be reduced in a case of the advertisement disc.

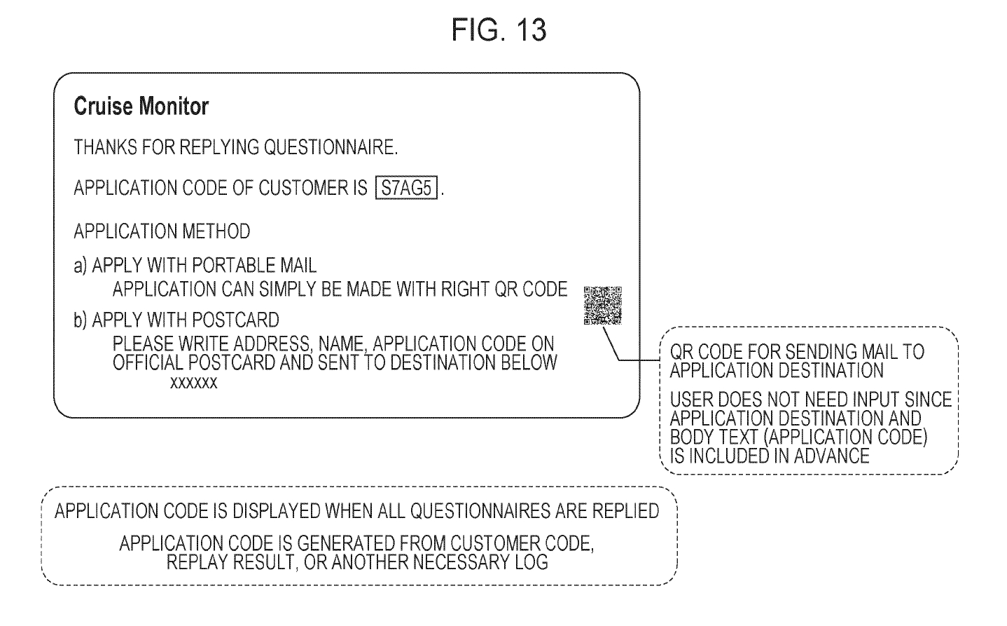

As the reproduction data, for example, a video (moving image) content item, a still image content item, a music content item, and various content items such as a pamphlet or a description, a questionnaire, present information, and a material request can be supplied. FIG. 13 is a diagram illustrating a picture example of a questionnaire and a present application. For example, this picture example is a picture example when a questionnaire is carried out to users in the reproduction course of an advertisement disc or a promotion disc. When the users reply to the questionnaire, an application code is displayed. The application code can be generated from a customer code, a reply result, or another necessary log.

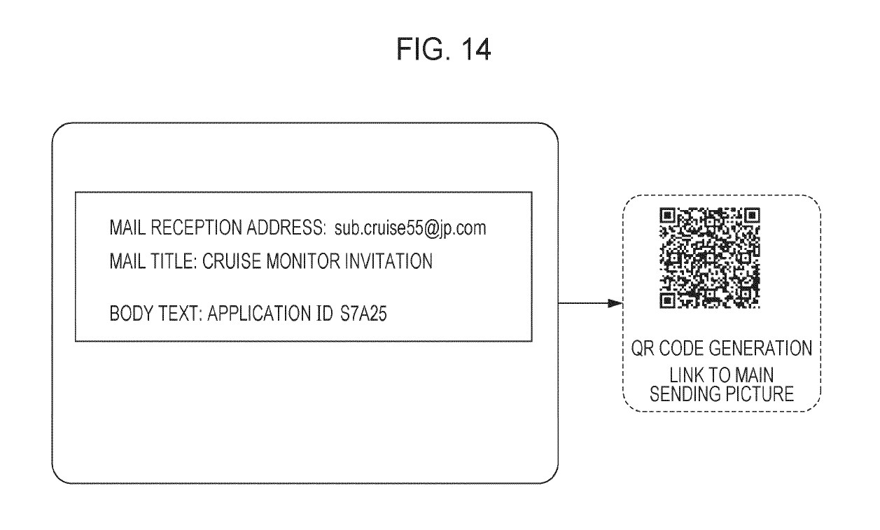

FIG. 14 is a diagram illustrating an example of the reproduction data displayed when reply data to the questionnaire is sent to the seller of the product using a QR code. The QR code may be used as user authentication or user identification as well as the above case where the reply data to the questionnaire is sent. For example, when network connection is possible in predetermined disc reproduction, the QR code is applicable to a process of acquiring a content item or a material suitable for the user from a predetermined server on a network in response to the user authentication or the user identification executed using the QR code and allowing the reproduction.

Further, when a material appropriate to the user can be acquired from a website, the advertisement or promotion content item of the details suitable for each user can be supplied by using the material. The QR code may be generated in advance and stored as the reproduction content item in the disc. Alternatively, a program (BD-J or Java (registered trademark)) stored in the disc may generate the QR code from user input information or the like.

### 6. Example of Configuration of Information Processing Apparatus Executing Content Item

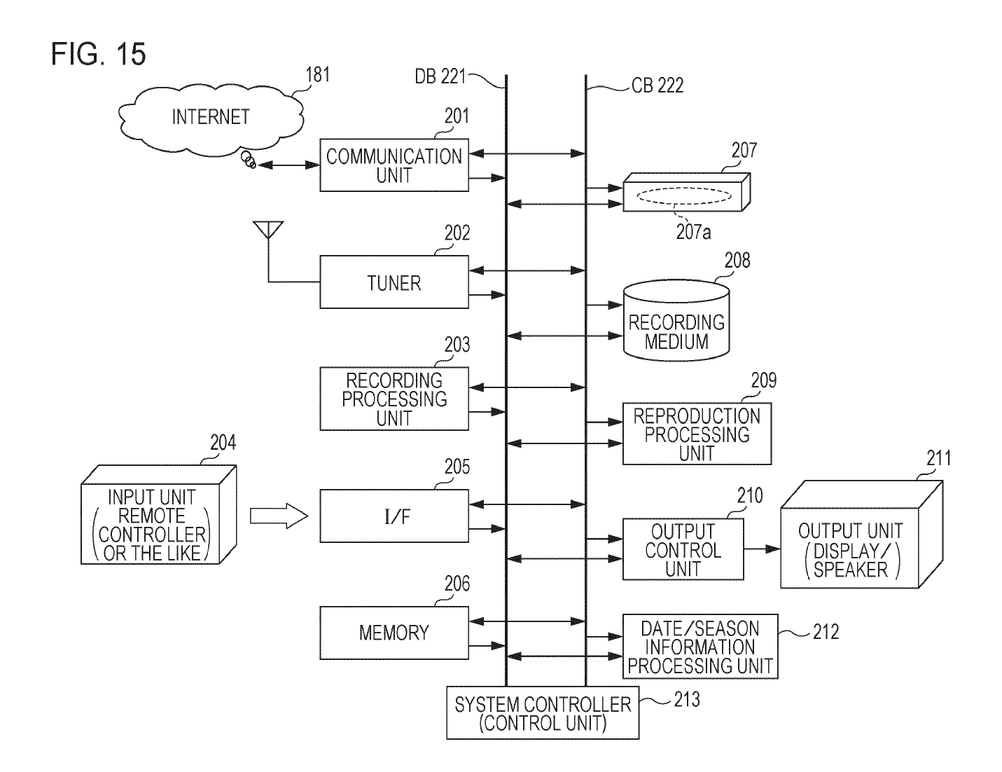

Next, an example of the configuration of the client reproducing a content item based on a scenario, that is, an information processing apparatus reproducing data from a medium such a BD will be described with reference to FIG. 15.

In the information processing apparatus, as shown in FIG. 15, each processing unit is connected to a data bus DB 221 and a control bus CB 222. Control data or processing data is input into or output from each processing unit based on a predetermined timing under the control of a system controller (control unit) 213.

A reproduction processing unit 209 of the information processing apparatus reproduces the recording data from a medium (information recording medium) 207a such as predetermined disc loaded on a medium drive 207 based on the scenario.

A recording processing unit 203 stores the content item acquired from the server via the Internet 181 and a communication unit 201 or the content item acquired from the outside via a tuner 202 in a recording medium 208 such as a hard disc.

The user input such as start or stop of the content item reproduction process or the input of the keyword is executed from an input unit 204 of a remote controller or the like via an I/F (interface) 205. The reproduction control program such as the BD-J is executed by the reproduction processing unit 209. The scenario selection process based on the keyword input by the user and the content item reproduction process based on the selected scenario, which are described above, are executed.

When the scenario selection process based on the disc ID and the content item reproduction process based on the selected scenario, which are described above, are executed, the disc ID is read by the reproduction processing unit 209. Then, the scenario selection process based on the disc ID and the content item reproduction process based on the selected scenario are executed.

The reproduction data is output via an output control unit 210 and an output unit 211 formed by a display, a speaker, or the like.

A memory 206 is used as a work area for processing various kinds of data, a parameter storage area, or the like in the information processing apparatus. The memory 206 is also used as a temporary storage area of communication data. When the content item is reproduced while acquiring predetermined material data such as image or audio data from the outside such as a server, the acquired data is stored in the memory 206. The acquired data can be read and reproduced from the memory 206 when the content item is reproduced.

The date/season information processing unit 212 acquires date information from a calendar clock function unit of the information processing apparatus to adaptively suggest the content item at a reproduction time to the user and supplies the date information to the reproduction processing unit 209.

The reproduction processing unit 209 can apply, for example, the date information as scenario selection information.

In the above-described embodiment, the scenarios selection processing examples of (a) the scenario selection based on the input of the user or the selection information (input/selection of keyword or code information) and (b) the scenario selection based on the disc ID have been described. However, various other settings can be made as information applied to the scenario selection.

Specifically, current date information can be applied as the scenario selection information. The date/season information processing unit 212 shown in FIG. 15 acquires the date information from the calendar clock function unit of the information processing apparatus and supplies the date information to the reproduction processing unit 209. The reproduction processing unit 209 applies, for example, the date information as the scenario selection information. Through the scenario selection, the content item suitable for spring can be reproduced in spring and the content item suitable for summer can be reproduced in summer.

The scenarios suitable for respective seasons are set in the disc for execution this process. Further, the reproduction control program (the BD-J or the like) is stored as a program which executes a process of acquiring the current date information and selecting the scenario based on the acquired date information.

Various kinds of information may be used as the information used to apply the scenario selection. For example, the scenario selection process can be executed based on a profile such as the age, sex, interests, and the like of the user or the scenario selection process can be executed based on a place.

Further, it is necessary to store the program and the scenario suitable for each process in the disc. That is, it is necessary to generate the program which executes respective processes such as the process of acquiring the scenario selection information and the scenario selection process based on the acquired information and to store the program in the disc. When place information is acquired, for example, a GPS function is prepared in the information processing apparatus. Then, a process of acquiring the place information and selecting the scenario based on the acquired place information can be executed.

The process of acquiring the content item for reproduction from the server has hitherto been described. However, the data for not only the content item for reproduction but also the program or the scenario may be acquired from the server via a network.

### 7. Content Item Reproduction Processing Sequence in Information Processing Apparatus

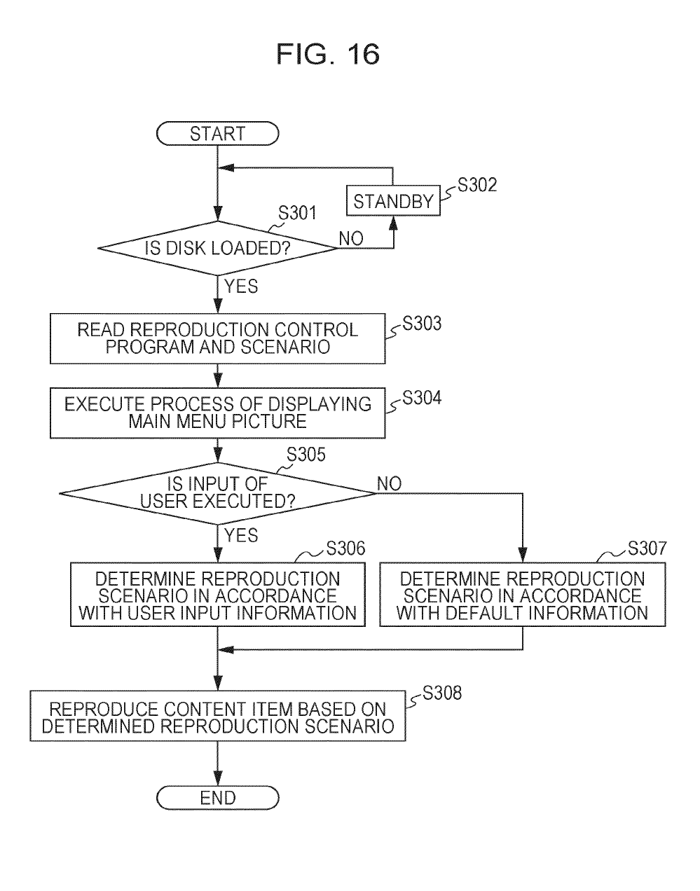

Next, content item reproduction processing sequences executed by the information processing apparatus according to the embodiment of the disclosure will be described with reference to the flowcharts of FIG. 16 and the subsequent drawings.

FIG. 16 is a flowchart illustrating a content item reproduction processing sequence in which the scenario is selected based on the user input information.

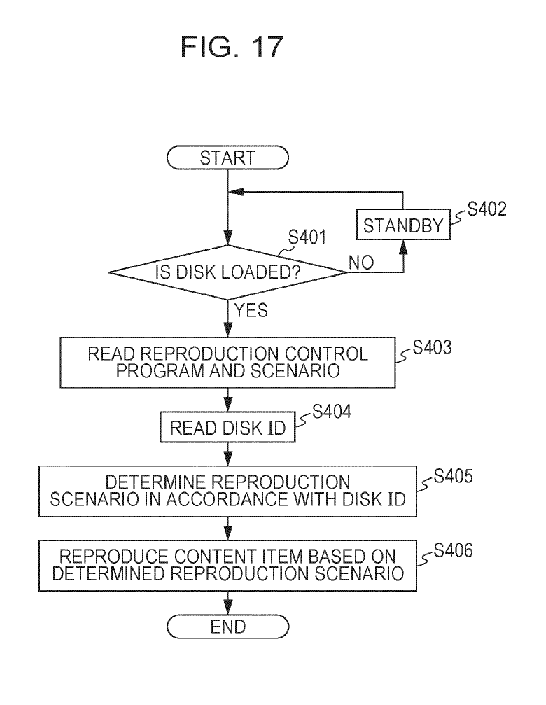

FIG. 17 is a flowchart illustrating a content item reproduction processing sequence in which the scenario is selected based on the disc ID.

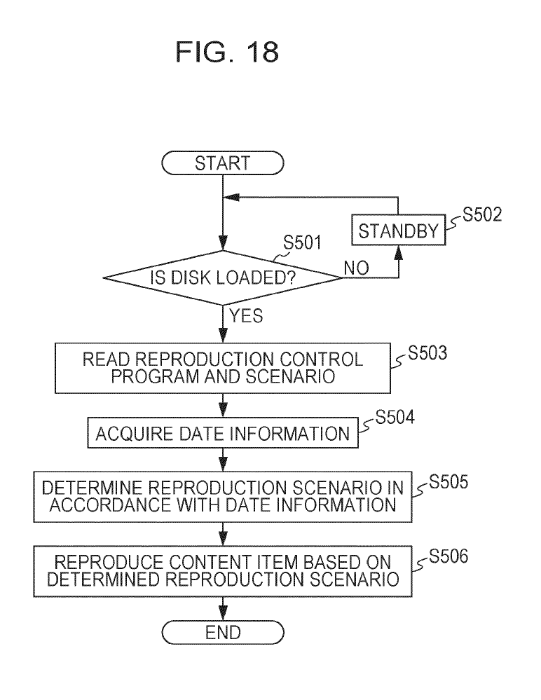

FIG. 18 is a flowchart illustrating a content item reproduction processing sequence in which the scenario is selected based on date information.

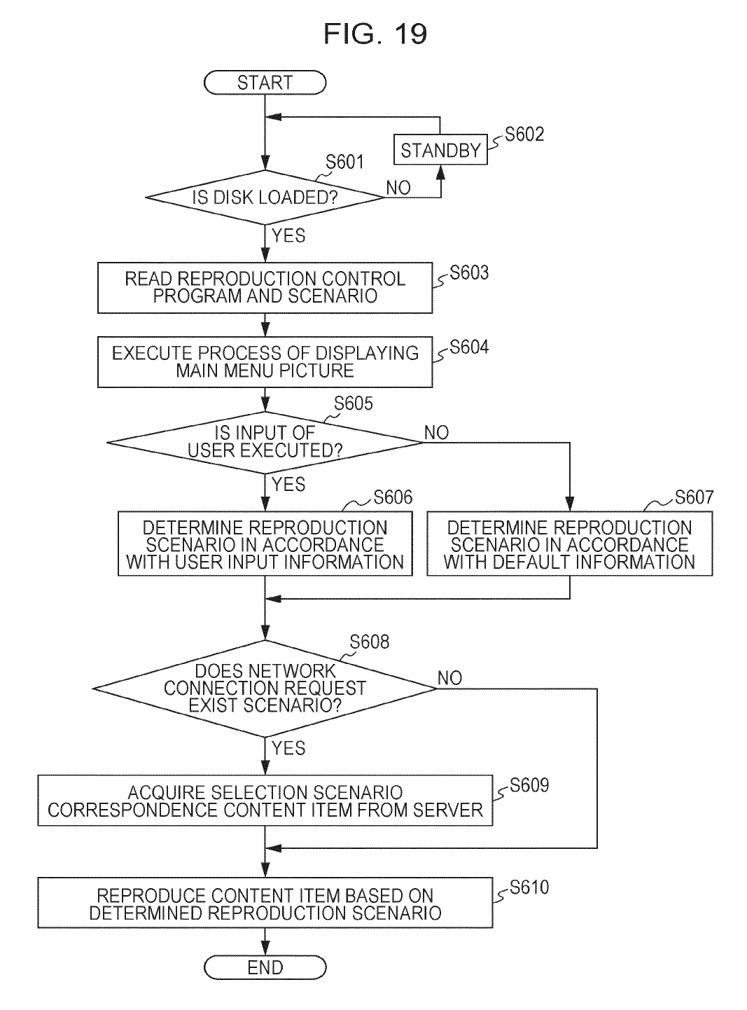

FIG. 19 is a flowchart illustrating a content item reproduction processing sequence in which the scenario is selected based on the user input information and the content item is acquired from the server via a network.

First, the content item reproduction processing sequence in which the scenario is selected based on the user input information will be described with reference to the flowchart of FIG. 16.

In step S301, it is determined whether the disc is loaded on the information processing apparatus. When it is determined that the disc is not loaded, the process stands by in step S302. When it is confirmed that the disc is loaded, the process proceeds to step S303.

The example of the content item reproduction process from the disc in accordance with the following flow will be described. However, the medium loaded on the information processing apparatus may be a flash memory or the like as well as the disc.

In step S303, the program and the scenario for controlling the reproduction of the content item is read from the loaded disc. The processes subsequent to step S303 is executed as, for example, the process of the reproduction processing unit 209 described with reference to FIG. 15. The program for controlling the reproduction of the content item may be, for example, a program such as BD-J when the loaded disc is a BD. The scenario read from the disc is scenario defining data including the plurality of scenarios in which various content item reproduction sequences can be set, as described above with reference to FIG. 7.

The scenario described in accordance with the flow is a scenario in which the reproduction content item can be modified based on the user input information.

The program includes a program which executes the process of acquiring the user input information and the process of selecting the scenario based on the acquired user input information.

In step S304, the process of displaying the main menu picture is executed. The main menu picture is a picture on which the process of selecting the scenario can be executed and the user inputs or selects the keyword or code information or the like. Specifically, the main menu picture is the picture or the like described above with reference to FIG. 2.

In step S305, it is determined whether the input of the user is executed. The input of the user is a direct input of the keyword or code information or an input of selection information. When the input of the user is detected, the process proceeds to step S306 and the scenario is selected based o the input information.

On the other hand, when the input of the user is not detected, the process proceeds to step S307 and the predefined default scenario is selected.

Subsequently, in step S308, the reproduction of the content item starts based on the scenario determined in step S306 or step S307.

Even after the reproduction of the content item starts, various controls such as the conversion of the reproduction content item or execution/stop of the loop process are executed in response to the key input of the user or after the elapse of the preset time, as described above with reference to FIGS. 8 to 11 and the like.

Next, the content item reproduction processing sequence in which the scenario is selected based on the disc ID will be described with reference to the flowchart of FIG. 17.

In step S401, it is determined whether the disc is loaded on the information processing apparatus. When it is determined that the disc is not loaded, the process stands by in step S402. When it is confirmed that the disc is loaded, the process proceeds to step S403.

In step S403, the program and the scenario for controlling the reproduction of the content item is read from the loaded disc. The processes subsequent to step S403 is executed as, for example, the process of the reproduction processing unit 209 described with reference to FIG. 15. The program for controlling the reproduction of the content item may be, for example, a program such as BD-J when the loaded disc is a BD. The scenario read from the disc is scenario defining data including the plurality of scenarios in which various content item reproduction sequences can be set, as described above with reference to FIG. 7.

The scenario described in accordance with the flow is a scenario in which the reproduction content item can be modified based on the user input information in accordance with the disc ID.

The program includes a program which executes the process of reading the disc ID and the process of selecting the scenario based on the read disc ID.

In step S404, the process of displaying the main menu picture is executed. The process of the reading the disc ID is executed as, for example, a reading process from the BCA region set in the disc.

In step S405, the scenario is selected based on the read disc ID.

Subsequently, in step S406, the reproduction of the content item starts based on the scenario determined in step S405.

Even after the reproduction of the content item starts, various controls such as the conversion of the reproduction content item or execution/stop of the loop process are executed in response to the key input of the user or after the elapse of the preset time, as described above with reference to FIGS. 8 to 11 and the like.

Next, the content item reproduction processing sequence in which the scenario is selected based on date information will be described with reference to the flowchart of FIG. 18.

In step S501, it is determined whether the disc is loaded on the information processing apparatus. When it is determined that the disc is not loaded, the process stands by in step S502. When it is confirmed that the disc is loaded, the process proceeds to step S503.

In step S503, the program and the scenario for controlling the reproduction of the content item is read from the loaded disc. The processes subsequent to step S503 is executed as, for example, the process of the reproduction processing unit 209 described with reference to FIG. 15. The program for controlling the reproduction of the content item may be, for example, a program such as BD-J when the loaded disc is a BD. The scenario read from the disc is scenario defining data including the plurality of scenarios in which various content item reproduction sequences can be set, as described above with reference to FIG. 7.

The scenario described in accordance with the flow is a scenario in which the reproduction content item can be modified based on the date information.

The program includes a program which executes the process of acquiring the date information and the process of selecting the scenario based on the read date information.

In step S504, the process of acquiring the date information is executed. For example, the process of acquiring the date information is executed in such a manner that the date/season information processing unit 212 acquires the date information from the calendar clock function unit of the information processing apparatus and supplies the date information to the reproduction processing unit 209, as described with reference to FIG. 15. In the reproduction processing unit 209, for example, the date information is applied as the scenario selection information.

In step S505, the scenario is selected based on the acquired date information. Subsequently, in step S506, the reproduction of the content item starts based on the scenario determined in step S505.

Even after the reproduction of the content item starts, various controls such as the conversion of the reproduction content item or execution/stop of the loop process are executed in response to the key input of the user or after the elapse of the preset time, as described above with reference to FIGS. 8 to 11 and the like.

Through the scenario selection in accordance with the flow, the content item suitable for spring can be reproduced in spring and the content item suitable for summer can be reproduced in summer.

Next, the content item reproduction processing sequence in which the scenario is selected based on the user input information and the content item is acquired from the server via the network will be described with reference to the flowchart of FIG. 19.

Since the process from step S601 to step S607 is the same as the process from step S301 to step S307 described above with reference to FIG. 16, the description thereof will not be repeated.

When the input of the user, that is, the direct input of the keyword or code information the input of the selection information is detected in step S605, the process proceeds to step S606 and the scenario is selected based on the input information.

On the other hand, when the input of the user is not detected, the process proceeds to step S607 and the predefined default scenario is selected.

Subsequently, in step S608, it is determined whether an execution request of the process of acquiring the content item through connection of the network is described in the scenario. The reproduction processing unit executes this determination process in accordance with the reproduction control program (for example, the BD-J).

When the execution request of the process of acquiring the content item through the connection of the network is described in the scenario, the process of acquiring the content item from the server is executed by executing the access to the server in step S609.

As the process of acquiring the content item, for example, a process of using the server URL or the content item URL described in the scenario can be used or a process of selecting and supplying the supply content item by the server based on the transmission of the disc ID to the server can be used.

A sequence in which the content item is acquired from the individual server is stored in the scenario described as the XML data. This sequence is analyzed and executed by the program (for example, the BD-J).

On the other hand, when the execution request of the process of acquiring the content item through the connection of the network is not described in the scenario, the process of acquiring the content item from the server in step S609 is skipped.

In step S610, the content item is reproduced based on the determination scenario. When there is the content item acquired from the server in step S609 in the individual content item reproduction process, the content item read from the disc and the content item acquired from the server are reproduced.

When the process of step S609 is skipped and there is no content item acquired from the server, only the content item stored in the disc is reproduced.

Even after the reproduction of the content item starts, various controls such as the conversion of the reproduction content item or execution/stop of the loop process are executed in response to the key input of the user or after the elapse of the preset time, as described above with reference to FIGS. 8 to 11 and the like.

The example has been described in FIG. 19 in which the content item reproduction processing sequence of the process of selecting the scenario based on the user input information and the process of the acquiring the content item from the sever via the network. However, the network connection process can be also used in the selection of the scenario based on the disc ID or the selection of the scenario based on the date information, as described with reference to FIG. 17.

### 8. Examples of Configurations of Server and Content Item Editing Apparatus

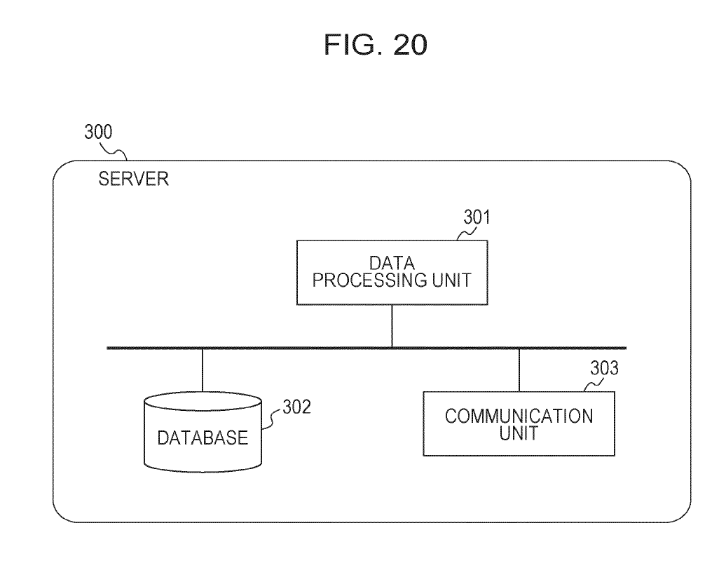

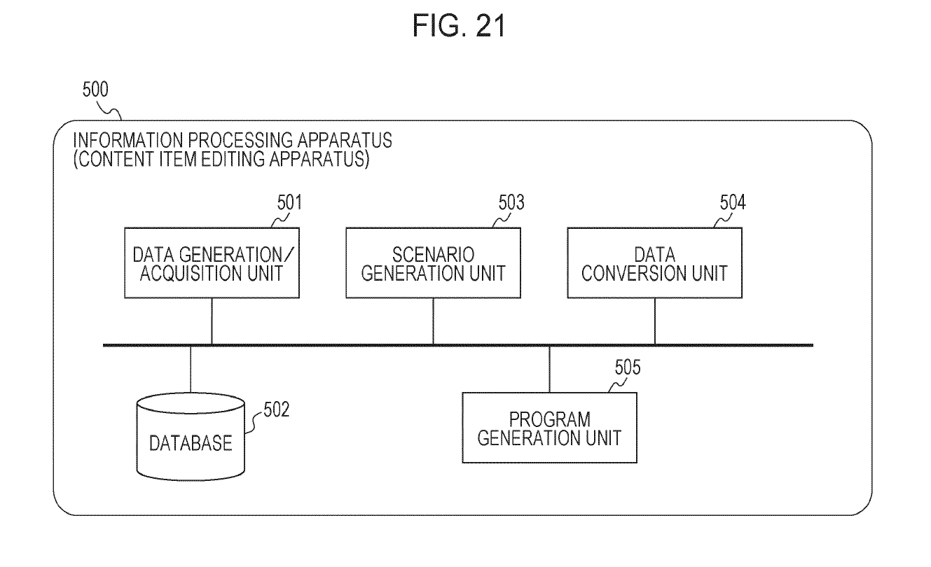

Next, examples of the configurations of the server and the content item editing apparatus will be described with reference to FIGS. 20 and 21.

FIG. 20 is a diagram illustrating an example of the configuration of the server. For example, the server supplies the content item or the like suitable for the scenario in response to a request from the client (reproduction apparatus) which loads a medium such as a BD.

As shown in FIG. 20, a server 300 includes a data processing unit 301, a database 302, and a communication unit 303.

The server 300 communicates with the client or the like via the communication unit 303.

For example, when a request for the content item with the disc ID is input from the client, the data processing unit 301 selects the content item suitable for the scenario corresponding to the disc specified by the disc ID, extracts the content item from the database 302, and supplies the content item to the client via the communication unit 303.

As described above, the server may supply the client with not only the reproduction data but also the scenario or the reproduction control program.

FIG. 21 is a diagram illustrating an example of the configuration of a content item editing apparatus 500. The content item editing apparatus 500 generates disc recording data described above with reference to FIG. 5.

The generated recording data includes at least the following data:

(a) the reproduction content item (a moving image, a still image, text data, or the like);

(b) the scenario (scenario defining another content item reproduction sequence in accordance with the scenario selection information); and

(c) the program (BD-J or the like) configured to reproduce the content item based on the scenario.

The content item editing apparatus 500 shown in FIG. 21 generates the data including the above-mentioned data (a) to (c) as recording data. For example, the generated data is supplied to a disc manufacturing company, a stamper is produced, and then the discs are manufactured in volume.

A data generation/acquisition unit 501 generates or acquires a video content item, a still image content item, text information, or the like as the reproduction data. For example, when the disc storing the above-described advertisement content item for the cruise is produced, data generation/acquisition unit 501 generates or acquires the video content item, the still image content item, the text information, or the like for the advertisement content item regarding the cruise.

The generated or acquired content item is stored in the database 502.

A scenario generation unit 503 generates the scenario which is the reproduction sequence definition information of the recording content item of the recording medium.

A data conversion unit 504 executes conversion to data suitable for the recording medium.

A program generation unit 505 generates the program suitable for the recording medium.

The scenario generated by the scenario generation unit 503 includes a plurality of different scenarios defining a plurality of different content item reproduction sequences. The program generated by the program generation unit 505 is a program which executes the process of acquiring the scenario selection information, the process of selecting the scenario based on the scenario selection information, and the content item reproduction process executed based on the selected scenario.

For example, when the recording medium is a BD, the program generation unit 504 generates the BD-J serving as the program in conformity with the BD standard.

The data conversion unit 504 generates the data having a hierarchical structure in conformity with the BD format described above with reference to FIG. 12, that is, the BD-J serving as the reproduction control program, the playlist file, the clip file, or the like.

The data generated in conformity with the medium standard in this way is generated as recording data and is supplied to a disc manufacturing company. The data is encrypted, if necessary. When the data is stored as the encrypted data in a medium, a decoding key is supplied to the client (reproduction apparatus). The client (reproduction apparatus) executes the reproduction process while executing a decoding process.

The description has hitherto been made according to the specific embodiment of the disclosure. It is apparent to those skilled in the art that the embodiment is modified or substituted within the scope of the disclosure without departing from the gist of the disclosure. That is, since the disclosure is described according to the exemplary embodiment, the disclosure is not construed as being limited. The appended claims have to be taken into consideration to determine the gist of the disclosure.

In the specification, the above-described series of processes may be executed by hardware, software, or a combination configuration thereof. When the processes are executed by software, the program recording a processing sequence may be installed in a memory of a dedicated hardware-embedded computer or may be installed in a general computer executing various kinds of processing so as to be executed. For example, the program may be stored in advance in a recording medium. As well as the installation from the recording medium to the computer, the program may be received via a network such as a LAN (Local Area Network) or the Internet and may be installed in a recording medium such as an internal hard disc.

The various processes described in the specification may be executed chronologically as in the description or may be executed in parallel or individually depending on the processing capability of the apparatus executing the processes or if necessary. The configuration of a system in the specification is a logical collective configuration of a plurality of apparatuses and is not limited to a configuration in which apparatuses with a configuration are included in the same casing.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a reproduction processing unit executing a process of reproducing a content item from a recording medium,
wherein the reproduction processing unit reads scenario data, which is reproduction sequence definition information of the content item stored in the recording medium, and a program, which executes reproduction control of the content item based on the scenario data, from the recording medium and reproduces the content time under the control of the program,
wherein the scenario data includes a plurality of different scenarios defining a plurality of different content item reproduction sequences, and
wherein the reproduction processing unit executes a process of acquiring scenario selection information, a process of selecting the scenario based on the acquired scenario selection information, and the process of reproducing the content item based on the selected scenario.

2. The information processing apparatus according to claim 1,
wherein the scenario selection information is keyword or code information input to a reproduction apparatus which loads the recording medium, and
wherein the reproduction processing unit executes a process of selecting a reproduction scenario based on the keyword or code information input to the reproduction apparatus.

3. The information processing apparatus according to claim 1,
wherein the scenario selection information is medium identification information set for the recording medium, and
wherein the reproduction processing unit reads the medium identification information of the recording medium loaded in the reproduction apparatus and executes the process of selecting the reproduction scenario based on the read medium identification information.

4. The information processing apparatus according to claim 1,
wherein the scenario selection information is date information acquired from the reproduction apparatus loading the recording medium, and
wherein the reproduction processing unit executes the process of acquiring the date information and the process of selecting the reproduction scenario based on the acquired date information.

5. The information processing apparatus according to claim 1,
wherein when the process of reproducing the content item acquired from a server is defined in the scenario, the reproduction processing unit acquires the content item from the server and executes the process of reproducing the content item.

6. The information processing apparatus according to claim 1,
wherein the reproduction processing unit executes the process of reproducing the content item in a predetermined sequence by the use of a playlist file defining content item reproduction sequence information, when the process of reproducing the content item is executed by applying the program executing the reproduction control of the content item based on the scenario.

7. The information processing apparatus according to claim 1,
wherein the playlist file has marks indicating a reproduction start position and a reproduction end position in a scene unit, which is a reproduction data unit, and the mark indicating the reproduction end position is set at a position before an actual data end position of a scene, and
wherein the reproduction processing unit starts a process for reproduction end of the scene or transition to another scene based on the mark indicating the reproduction end position.

8. An information processing apparatus comprising:
a scenario generation unit generating a scenario which is reproduction sequence definition information of a content item stored in a recording medium; and
a program generation unit generating a program which executes reproduction control of the content item based on the scenario,
wherein the scenario generated by the scenario generation unit includes a plurality of different scenarios defining a plurality of different content item reproduction sequences, and
wherein the program generated by the program generation unit is a program executing a process of acquiring scenario selection information, a process of selecting the scenario based on the acquired scenario selection information, and a process of reproducing the content item based on the selected scenario.

9. The information processing apparatus according to claim 8,
wherein the scenario selection information is keyword or code information input to a reproduction apparatus which loads the recording medium, and
wherein the program executes a process of selecting a reproduction scenario based on the keyword or code information input to the reproduction apparatus.

10. The information processing apparatus according to claim 8,
wherein the scenario selection information is medium identification information set for the recording medium, and
wherein the program executes a process of reading the medium identification information of the recording medium loaded in the reproduction apparatus and the process of selecting the reproduction scenario based on the read medium identification information.

11. The information processing apparatus according to claim 8,
wherein the scenario selection information is date information acquired from the reproduction apparatus loading the recording medium, and
wherein the program executes the process of acquiring the date information and the process of selecting the reproduction scenario based on the acquired date information.

12. An information recording medium storing:
a content item to be reproduced;
scenario data which is reproduction sequence definition information of the content item to be reproduced; and
a program executing reproduction control of the content item based on the scenario data,
wherein the scenario data includes a plurality of different scenarios defining a plurality of different content item reproduction sequences, and
wherein a reproduction apparatus loading the information recording medium and reproducing the content item is able to execute a process of acquiring scenario selection information based on the program, a process of selecting the scenario based on the acquired scenario selection information, and a process of reproducing the content item based on the selected scenario.

13. The information recording medium according to claim 12,
wherein the information recording medium stores a playlist file defining content item reproduction sequence information,
wherein the playlist file has marks indicating a reproduction start position and a reproduction end position in a scene unit, which is a reproduction data unit, and the mark indicating the reproduction end position is set at a position before an actual data end position of a scene, and
wherein the reproduction apparatus loading the information recording medium and reproducing the content item is able to start a process for reproduction end of the scene or transition to another scene based on the mark indicating the reproduction end position and to execute the transition to the scene without delay.

14. An information processing method executed in an information processing apparatus,
wherein the information processing apparatus includes a reproduction processing unit executing a process of reproducing a content item from a recording medium,
wherein the reproduction processing unit reads scenario data including a plurality of different scenarios defining a plurality of different content item reproduction sequences and a program executing reproduction control of the content item based on the scenario data, and
wherein the reproduction processing unit acquires scenario selection information based on the program, selects the scenario based on the acquired scenario selection information, and reproduces the content item based on the selected scenario.
